(19) United States
(12) Patent Application Publication
(10) Pub. No.: US 2003/0078798 A1
(43) Pub. Date: Apr. 24, 2003

(54) Computerized maintenance management system

(75) Inventors: Joseph David Zaks, Milwaukee, WI (US); Bonnie M. Pionke, Milwaukee, WI (US); Jeffrey E. Grzeca, Milwaukee, WI (US); Craig C. Wentworth, Milwaukee, WI (US); Dean Honadel, Milwaukee, WI (US); Matthew Francis Michala, Milwaukee, WI (US); Janelle Harvey, Oconomowoc, WI (US); Ted Cain, Waterford, WI (US); Tracey Nguyen, Milwaukee, WI (US)

Correspondence Address: MICHAEL BEST & FRIEDRICH, LLP, 100 E WISCONSIN AVENUE, MILWAUKEE, WI, 53202, US

(73) Assignee: Milwaukee Public Schools, Milwaukee, WI

(21) Appl. No.: 10/190,468

(22) Filed: Jul. 5, 2002

Related U.S. Application Data
(60) Provisional application No. 60/303,279, filed on Jul. 5, 2001.

(51) Int. Cl. G06F 17/60

(52) U.S. Cl. 705/1

(57) ABSTRACT

A computerized maintenance management system for handling, among other things, an organization's payroll, billing, maintenance needs, employee information, employee time sheets, purchasing, inventory, environmental issues, reports, census information, school safety issues, equipment identification, vendor access, and user security. The system includes various modules that work together to manage all aspects of a maintenance facility's work orders generated to maintain the organization's buildings and other structures. A work order module is used for entering, tracking, and communicating the work orders to various organization personnel.

### RELATED APPLICATIONS

This application claims priority to U.S. provisional patent application Ser. No. 60/303,279, filed Jul. 5, 2001.

### BACKGROUND OF THE INVENTION

The present invention relates to management systems. More particularly, the invention relates to a computerized maintenance and operational management system.

In any organization, it is vital that certain operations are well managed. The larger and more complex the organization is, the greater the need for structured or engineered management. In many organizations a great deal of time is spent on activities that are peripheral to the organization's main objective. Activities such as inventory management, purchase order tracking, billing, and other tasks are often tedious but fundamental to success.

A variety of computer and software products are available, but few are suitable for organizations with sophisticated facilities management needs such as large corporations with multiple facilities or campuses, universities, and school systems. Large school systems can have tens of thousands of students, thousands of faculty and staff members, hundreds of buildings, and multi-billion dollar budgets. While the main objective of the school system is educating students, managing and maintaining the facilities used for teaching and extracurricular activities is a significant task itself. School systems sometimes hire external experts such as electrical, plumbing, carpentry, cleaning, landscaping, and similar contractors to conduct maintenance and repairs on facilities. More commonly, however, school systems rely on in-house equivalents to perform these services. Often hundreds of employees and tens of “shops” organized by trade or specialty are involved.

Currently, managing requests for services, inventory, human resources, time entry, payroll, and providing information and materials and managing funds needed to complete the facilities maintenance services is accomplished using a hodgepodge of manual and computer systems.

Manual systems are slow and rely on human data entry and processing, which can be error prone. In addition, sharing information among multiple users is difficult in such systems. Most available software packages have the capability of managing single operations such as inventory, purchase orders, billing, vendor contacts, etc. However, when an integrated or whole-organization approach is desired, these systems are unsatisfactory. Either custom modifications must be made to add needed functionality or discrete systems must be integrated to provide a system that handles all the operations associated with sophisticated management. Another deficiency of available management software is that it is denormalized, requiring numerous redundant fields and inputs. This makes modifying the software, organizing and maintaining databases, and keeping all occurences of the data values up-to-date difficult.

### SUMMARY OF THE INVENTION

Accordingly, there is a need for improved management systems for organizations with complex facility maintenance needs.

The invention provides a system for computerizing, automating, and integrating the various components and actions involved in requesting and managing maintenance services. In one embodiment, the system uses multiple programs (modules) to organize various aspects of the services offered, and provides the users with easy ways to view desired data. The system allow customers to request repairs via a network (e.g., the Internet) as well as find and edit existing requests. The system also allows accountants to track what services have been billed and what projects are not yet billed or funded; allows employees to log hours electronically; allows employers to sort and store information regarding each employee (training, skills, rates, overtime, absences, emergency information, etc.); allows for the measurement of costs of vendors, contracts, and projects; and automates inventory, order processing, receiving, and identification through the use of bar codes and similar identifying tags.

The system also generates fire prevention and safety evaluation checklists electronically for engineers and automatically generates repair requests from evaluation checklist results and allows maintenance staff to view the repair requests and information regarding the request. The system not only provides access to the above information for the different parties (customer, contractor, vendor, employer, employee, etc.), but also provides this access through one integrated system.

The system stores a plethora of information ranging from financial data (payroll, accounts payable, accounts receivable, billing data, etc.) to security (floor plans, systems, etc.) to personnel information. It also allows for multiple user access via the Internet and Intranet; as well as client/server communications. To avoid the unwanted or inadvertent access to confidential or restricted data, the participating parties (customer, contractor, sub-shops, vendors, etc.) only have access to the pertinent information relevant to their role and activities.

In one embodiment, the modules used to interact with the users and process their requests include a computerized on-line work-order system (“COWS”), an Intranet on-line repair request system (“Intranet ORR” or “ORR”), a commitment of money system (“COMS”), a child census module, an employee resource measurement system (“ERMS”), a purchase order and credit card system (“POS”), an automatic identification system (“AutoID”), a materials inventory measurement system (“MIMS”), a school safety system (“SSS”), a cyclic maintenance system (“CMS”), an environmental data management system (“EDMS”), a drawing or image viewer, which in one embodiment takes the form of a Volo View® system (“VVS”), and a time sheet entry (“TSE”) module.

In one embodiment, the invention provides a computerized maintenance management and information distribution system. The system includes a shop terminal, a school terminal, a public terminal, an administration terminal, a central office terminal, and a server. The terminals and the server are coupled to a network. The server includes a site accessible by the shop terminal, the school terminal, the public terminal, the administration terminal, and the central office terminal. The site also includes tools to manage maintenance and operations of a facility.

The tools may include a work order module, an employee resource module, a materials and inventory module, a purchase order module, a reporting module, a time sheet entry module, an environmental data management module, a census application module, a cyclic maintenance module, an image viewer module, a setup and security module, a school safety module, a work order request module, a commitment of money module, an automatic identification module, and a purchasing card module.

In another embodiment, the invention provides a work order module for use in a computerized maintenance management and information distribution system. The work order module is operable to generate a summary screen to view an existing work order based on a shop code, a search screen to search for a work order, and a detail screen to enter data describing the nature of the work performed on a work order. The work order module may also be operable to generate an estimate screen to prepare an estimate to complete the work order.

In another embodiment, the invention provides a computerized work order request module for use in a computerized maintenance management and information distribution system. The work order request module is operable to generate a preview screen to view an existing work order and select an existing work order for review, a detail screen to enter data describing the nature of a work order request, and an image screen to view floor plans and select the area for the work order request.

In another embodiment, the invention provides a method of communicating a computerized work order request to multiple parties having access to a computerized maintenance management and information distribution system. The method includes the acts of accessing a site on a server using a computer terminal, entering data on at least one work order request screen to describe the nature of the work order request, and transmitting the work order request information to the server and to other computer terminals.

In another embodiment, the invention provides a method of retrieving an existing work order. The method includes the acts of accessing a site using a computer terminal having access to the network, entering data on at least one work order search screen to describe the work order to be retrieved, and displaying work order request information on the computer terminal.

In another embodiment, the invention provides a purchase order and credit card module for use in a computerized maintenance management and information distribution system. The purchase order and credit card module is operable to generate a vendor screen to identify the vendor of a purchase order, a billing screen to display the costs of the vendor to complete the purchase order, a payment screen to display the amount to be paid to the vendor of the purchase order, and an authorization screen to authorize the purchase order for payment.

In another embodiment, the invention provides a materials and inventory module for use in a computerized maintenance management and information distribution system. The materials and inventory module is operable to generate a search screen to search for an inventory item, an inventory screen to identify the availability of the inventory item, an inventory requisition screen to remove the inventory item from stock, and a report screen to generate inventory reports.

In another embodiment, the invention provides a method of requisitioning an inventory item using a materials and inventory module. The method includes the acts of accessing a site on a server using a computer terminal, entering data on at least one inventory screen to describe the inventory item, displaying inventory information of the inventory item on the computer terminal, entering a quantity requested value on the at least one inventory screen, and transmitting the data entered on the at least one inventory screen to the server.

In another embodiment, the invention provides a time sheet entry module for use in a computerized maintenance management and information distribution system. The time sheet entry module is operable to generate a time entry screen to enter time worked data, a search screen to search for an employee, a summary screen to review the data entered on the time entry screen, and a report screen to generate labor reports.

In another embodiment, the invention provides an environmental data management module for use in a computerized maintenance management and information distribution system. The environmental data management module is operable to generate a menu screen to access environmental information, a search screen to select a location for reviewing environmental information, an environmental data screen to view environmental information for the location, and a report screen to generate an environmental report.

In another embodiment, the invention provides a census application module for use in a computerized maintenance management and information distribution system. The census application module is operable to generate an address screen to identify a location for obtaining census information, an occupants screen to identify the persons residing at the location on the address screen, a questions screen to identify questions to ask the persons in the occupants screen, and a contacts screen to identify other persons used to obtain the census information for the location.

In another embodiment, the invention provides a cyclic maintenance module for use in a computerized maintenance management and information distribution system. The cyclic maintenance module is operable to generate a cyclic maintenance screen to identify a primary component, a search screen to select the primary component of interest, an inflation rate screen to identify the annual inflation rate, and a cost screen to identify the cost to replace the primary component based on the inflation rate.

In another embodiment, the invention provides a school safety module for use in a computerized maintenance management and information distribution system. The school safety module is operable to generate an automatic checklist to review items for periodic maintenance, a survey screen to indicate the condition of the item, and a questionnaire screen to answer questions related to the item.

These features as well as other advantages of the invention will become apparent upon consideration of the following detailed description and accompanying drawings.

### BRIEF DESCRIPTION OF THE DRAWINGS

FIG. 1A is a schematic diagram of a computerized maintenance management system according to one exemplary embodiment of the invention.

FIG. 1B is a schematic diagram of a networking structure of the exemplary computerized maintenance management system.

FIG. 2 is a client/server main menu screen of the exemplary computerized maintenance management system.

FIG. 3 is a work order summary screen of the exemplary computerized maintenance management system.

FIG. 4 is a shop work order screen of the exemplary computerized maintenance management system.

FIG. 5 is a web page of the exemplary computerized maintenance management system.

FIG. 6 is a login screen to an exemplary work order request module.

FIG. 7 is an Intranet main menu screen of the exemplary work order request module.

FIG. 8 is a work order request browser menu screen of the exemplary work order request module.

FIG. 9 is a work order detail screen of the exemplary work order request module.

FIG. 10 is a building detail screen of the exemplary work order request module.

FIG. 11 is a drawing of a building from the exemplary work order request module.

FIG. 12 is a purchase order screen of an exemplary purchase order and credit card module.

FIG. 13 is an inventory request screen of an exemplary materials and inventory module.

FIG. 14 is a time sheet entry screen of an exemplary time sheet entry module.

FIG. 15 is a time sheet entry report screen of an exemplary time sheet entry module.

FIG. 16 is a payroll screen of the exemplary time sheet entry module.

FIG. 17 is an environmental menu screen of the exemplary environmental data management module.

FIG. 18 is an environmental data management screen of the exemplary environmental data management module.

FIG. 19 is a census information web page of the exemplary computerized maintenance management system.

FIG. 20 is a census data entry screen of an exemplary census application module.

FIG. 21 is a cyclic maintenance main menu screen of an exemplary cyclic maintenance module.

FIG. 22 is a projects data screen of the exemplary cyclic maintenance module.

FIG. 23 is a components data screen of the exemplary cyclic maintenance module.

FIG. 24 is a component conditions data screen of the exemplary cyclic maintenance module.

FIG. 25 is a recalculate inflated costs screen of the exemplary cyclic maintenance module.

FIG. 26 is a school safety survey of an exemplary fire prevention and school safety module.

FIGS. 27A-27O illustrate a data model defining the underlying database architecture of the system used in one embodiment of the invention.

### DETAILED DESCRIPTION

Before embodiments of the invention are explained in detail, it is to be understood that the invention is not limited in its application to the details of the construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items.

In some of the examples discussed, terms within quotation marks and capitalized terms are used for convenience and to assist the reader in correlating the description to the drawings. However, these terms should not be considered as having specialized meanings and are meant to be interpreted broadly and generically.

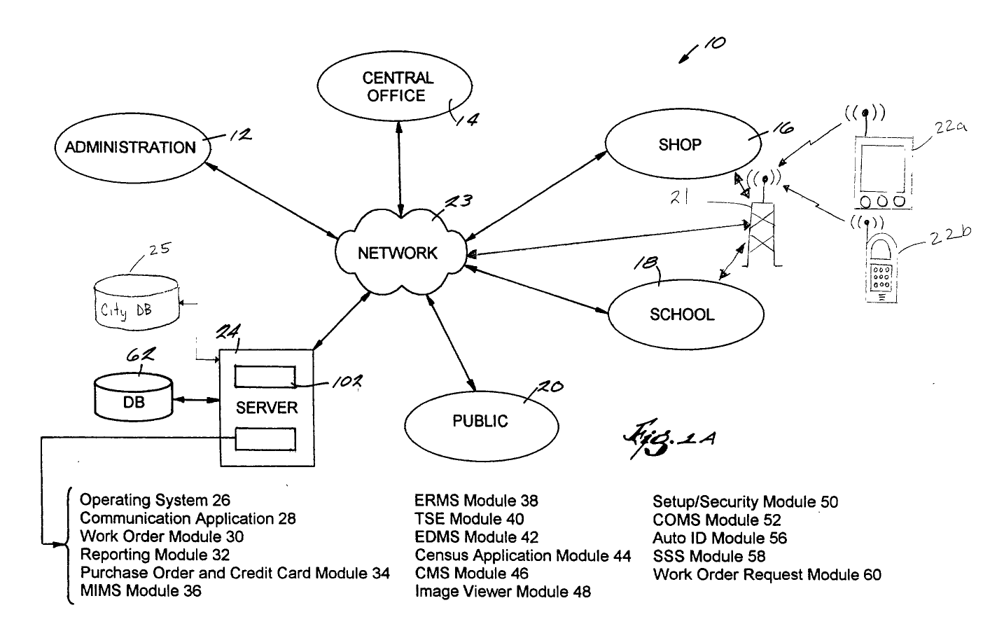

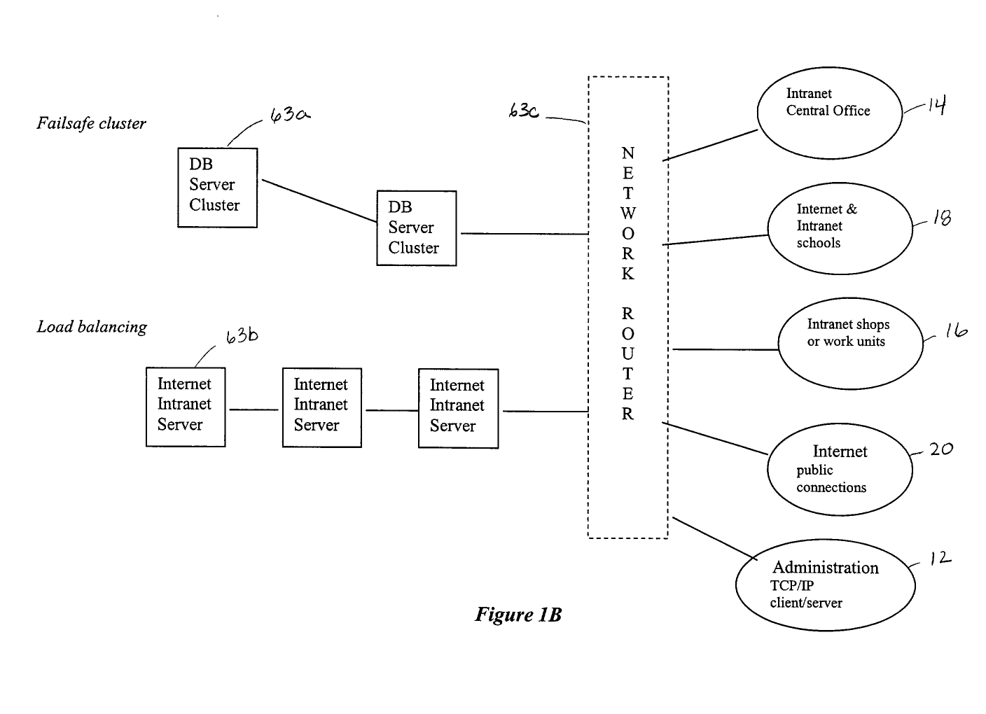

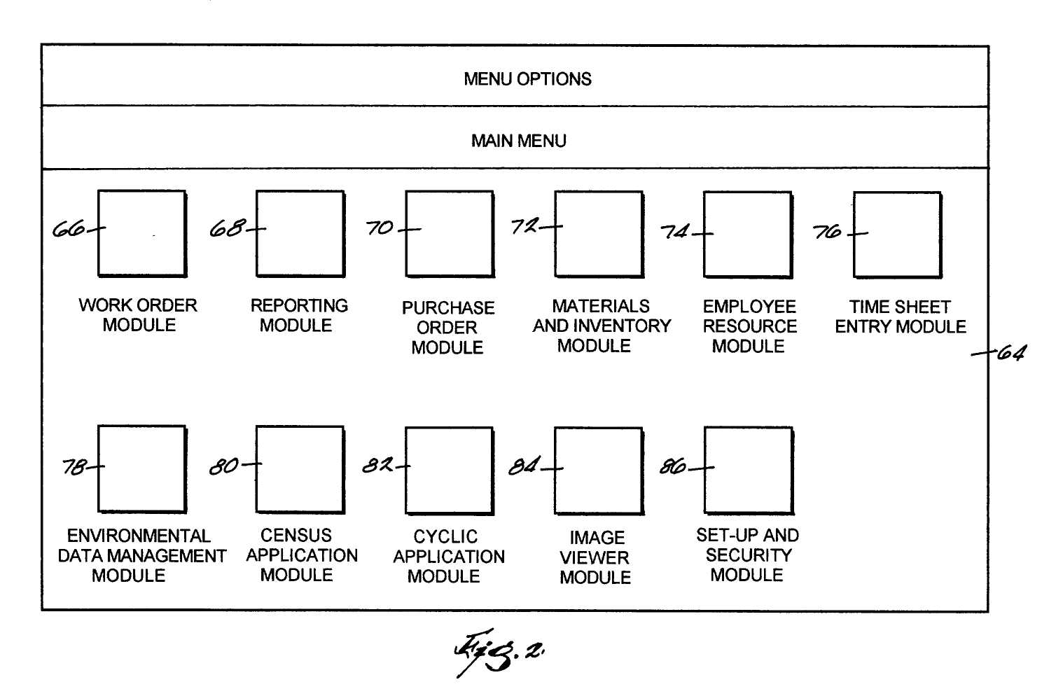

FIG. 1A schematically illustrates one embodiment of the invention. Other embodiments that include fewer or more terminals or components than are shown in FIG. 1 are also encompassed by the invention. FIG. 1 illustrates a network-based system 10. The system 10 includes a plurality of computer terminals: a system administration terminal 12, a central office terminal 14, a shop terminal 16, a school terminal 18, a public terminal 20, and a wireless terminal 21. Terminals 12, 14, 16, 18, 20, and 21 may be desktop computers, laptop computers, hand-held computing devices, wireless devices, for example, wireless device 22a, phones, for example, cell phone 22b, Internet appliances, and similar devices capable of communications over a network 23. The terminals may include standard input and output devices such as a mouse, keyboard, printer, magnetic and optical storing devices, and a display. Of course, the terminals could include a host of advanced and/or yet to be developed input and output devices such as voice recognition devices, biometric devices, etc. The terminals 12, 14, 16, 18, and 20 may include an operating system, a browser, and a communication application for communicating with a server 24 and each of the other terminals 12, 14, 16, 18, and 20 via the network 23. Preferably, the browser is a web-based browser, such as a Microsoft Explorer browser or a Netscape Communicator browser. Network 23 may be built according to any networking technology or topology or combinations of technologies and topologies and may include multiple sub-networks. Connections between the terminals 12, 14, 16, 18, and 20 may be made through local area networks (“LANs”), wide area networks (“WANs”), public switched telephone networks (“PSTNs”), Intranets, the Internet, and other networks.

The two-way arrows in FIG. 1 represent the two-way communication and information transfer between the network 23, the server 24, and the terminals 12, 14, 16, 18, and 20. Further, although not shown, the system 10 can be scaled to include numerous administrator terminals, central office terminals, shop terminals, school terminals, public terminals, and other terminals.

The server 24 includes an operating system 26, a communication application 28, a work order module 30, a reporting module 32, a purchase order and credit card module 34, a materials and inventory module 36, an employee resource module 38, a time sheet entry module 40, an environmental data management module 42, a census application module 44, a cyclic maintenance module 46, an image viewer module 48, a setup and security module 50, a commitment of money and billing module 52, an automatic identification module 56, a fire prevention and school safety module 58, and a work order request module 60 (each individually discussed below) accessible by the terminals 12, 14, 16, 18, and 20. The server 24 is also coupled to one or more databases 62.

FIG. 1B illustrates one possible networking structure of the system 10. One or more database server clusters 63a and one or more Internet/Intranet servers 63b are connected to a network router 63c. The system administration terminal 12, the central office terminal 14, the shop terminal 16, the school terminal 18, and the public terminal 20 are also in communication with the network router 63c.

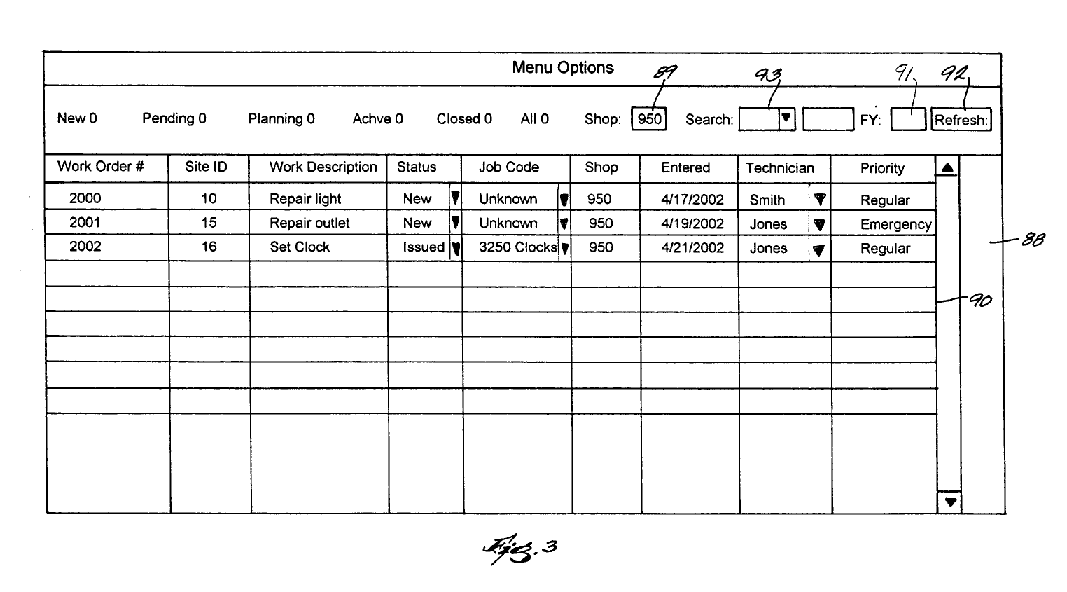

FIG. 2 illustrates an interactive screen 64 (i.e., a menu screen) of the system 10 for accessing the various modules listed above. The terms “screen” and “page” can refer to any grouping or association of data regardless of the presentation formatting or programming used to create the grouping or association. As such, all of the screens of system 10 are not limited to the arrangement as shown in any of the drawings. The screens may include, but are not limited to fields, dialog boxes, tabs, buttons, radio buttons, and drop down menus. Field titles may vary and are not limited to that shown in the drawings. The screen 64 may provide access to different modules other than those shown in FIG. 2 depending upon the authorization level of the user of the terminals 12, 14, 16, 18, and 20, as determined by the system administrator through the system administration terminal 12. For example, as shown in FIG. 2, the screen 64 displays access to the work order module 30, the reporting module 32, the purchase order module 34, the materials and inventory module 36, the employee resource module 38, the time sheet entry module 40, the environmental data management module 42, the census application module 44, the cyclic maintenance module 46, the image viewer module 48, and the setup and security module 50. Each module 30-50 is accessible by activating or clicking on an icon or link 66-86 associated with the module 30-50, respectively, with a computer mouse, keyboard, or like device.

Work Order Module 30

The work order module 30 measures financial and non-financial information related to work order requests. The measurement information of the work order module 30 allows an organization to be cost conscious by remaining within budgetary constraints. Work order requests may include one or several tasks depending upon the nature of the work requested to be performed. The work order module 30 is an effective communication tool that provides a current status of any work order request or task.

The work order request changes status as work is being performed, and an audit trail is generated to analyze workflow. Various attributes of the workflow audit trail may be analyzed using known statistical process control measurement tools. The statistical process control measurements provide variance data of the various attributes to indicate true cost accounting and performance information. The variance data also provides information on estimated and actual costs, budgeting, and funding for a work order. True cost accounting and performance information is measured and available based on the following attributes: cost center, facility, building, department, area, equipment, asset, vehicle, shop, job codes and descriptions, personnel, trade, warehouse/stockroom, materials, and outside purchases of material and services.

The work order module 30 is integrated with other modules such as the employee resource module 38, the materials and inventory module 36, the purchase order and credit card module 34, a commitment of money and billing module 52, a work order request module 60, and an automatic identification module 56. The integration of these modules provides a seamless system that performs both measurements (cost accounting) and non-measurements (performance) of an entire organization.

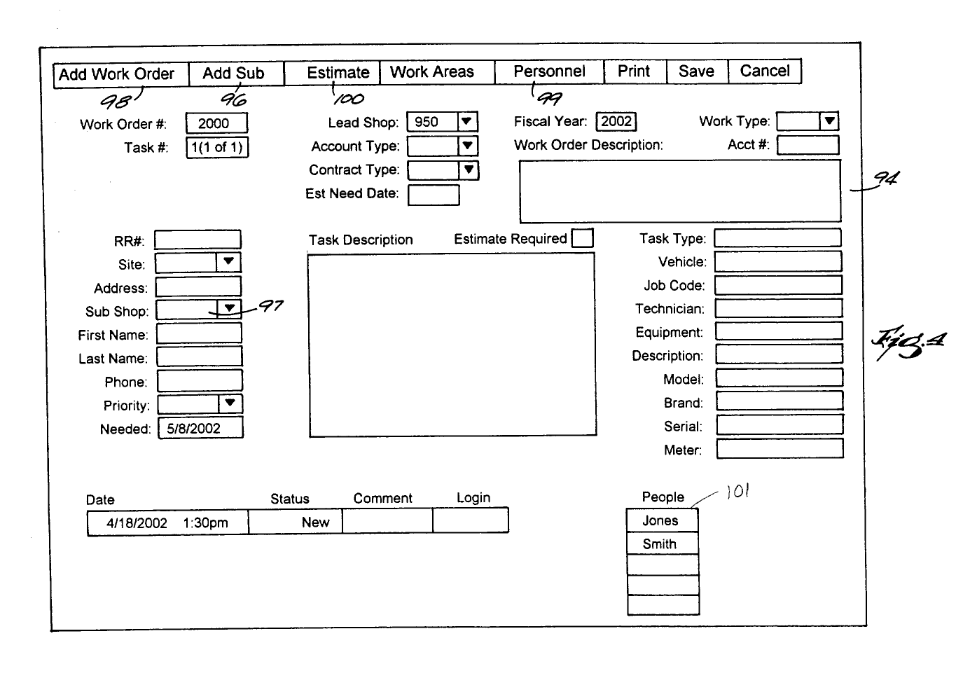

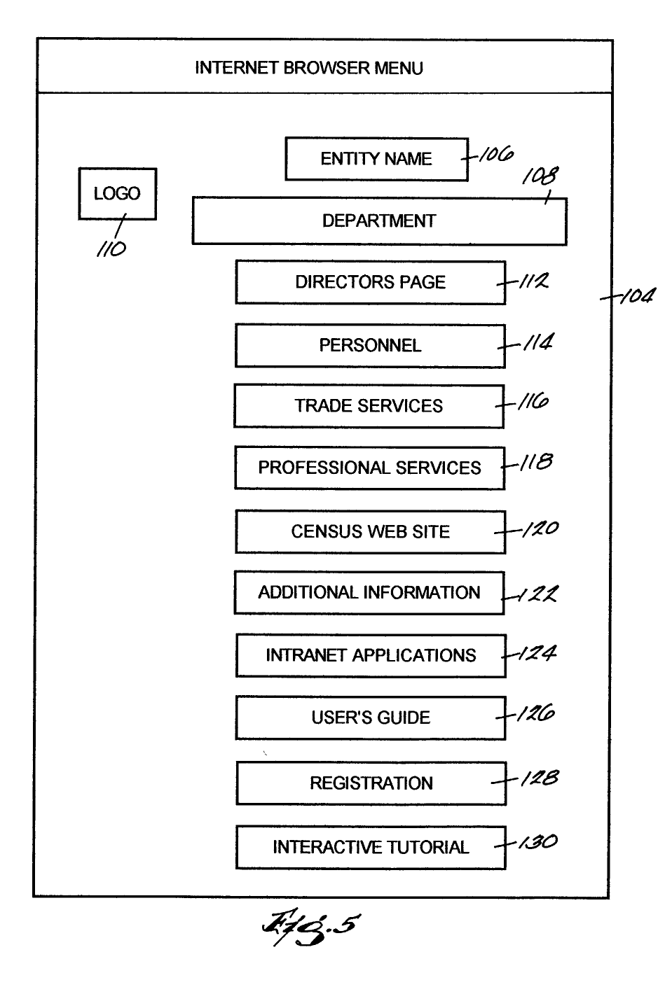

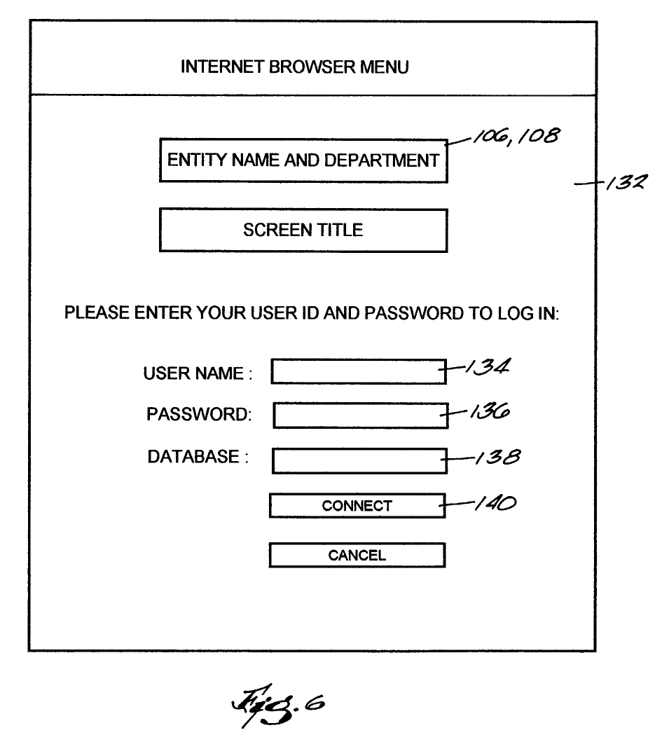

A shop worker may access the work order module 30 to view work orders that have been entered into the system 10 by organization personnel using the work order request module 60. The work order request module 60 is a tool utilized for communicating with a shop to request that work be performed. After the work order is entered into the system 10, the shop requested to perform the work receives notification of the newly entered work order. A shop worker accesses the work order module 30 by logging onto the system 10 and then clicking on icon or link 66 on the screen 64 (FIG. 2). The work orders for a particular shop appear on the shop terminal 16, as illustrated in FIG. 3. FIG. 3 illustrates a work order summary screen 88 with all work orders in the system 10 for a particular shop. The shop worker can view all of the work orders or can view specific work orders based on status, e.g., new, pending, planning, active, closed, or all status conditions. In addition, the shop worker can search for work orders based on a shop identification 89, a year 91 the work order was entered into the system 10, and other miscellaneous search criteria 93 (e.g., account type, contract type, description, lead shop, repair request, site name, site number, task type, technician, vehicle, W.O. type, work order, and job code). In a detail area 90, the shop worker can change the status of a work order, the job code, and the technician by selecting the drop-down menu next to each field. A refresh button 92 is provided to update the screen 88 to reflect the changes made. The work order status is changed by the shop worker to pending, planning, issued, and completed as the work progresses. The shop worker can view further details and status of a particular work order as illustrated in FIG. 4.

FIG. 4 illustrates a shop work order screen 94. The shop terminal 16 reviews “new” work orders and may plan various tasks to complete the work order. The information on this screen 94 appears as entered by the requester through the work order request module 60. The initial work order with one task description could be turned into a request with many sub-task descriptions as the requested shop manages the work order. The shop worker clicks on an add Sub button 96 to add additional tasks. The shop worker can also select a sub-shop to complete the sub-task. The shop worker can add work orders to the system 10 using an add work order button 98 and completing the information fields as described below with respect to the work order request module 60. The shop worker completes an estimate of the work to be performed by clicking on an estimate button 100. In an estimate screen (not shown) the shop worker can select inventory items and quantity, the type of labor to be performed, whether vendor assistance may be needed, and type of labor and transportation. The cost for each selection is included in the estimate. The estimate is saved to the work order. The shop terminal user may also reassign the work order to a different shop than indicated by the requester of the work order. The shop worker may return the work order to the requester for missing or incorrect information. The shop worker may assign one or more employees to the work order or to sub-tasks by selecting a personnel button 99. As an employee is selected, his or her name appears on the shop work order screen 94 in the people area 101.

As the work is being performed, the shop workers assigned to perform the work enter their hours worked on work orders in the time sheet entry module 40 (discussed below) coded to the work order number. By entering information in this manner, administrators are able to determine how much each work order costs and can project funds availability for future work orders, because both materials information and labor information is in one system.

Work Order Request Module (“ORR”) 60

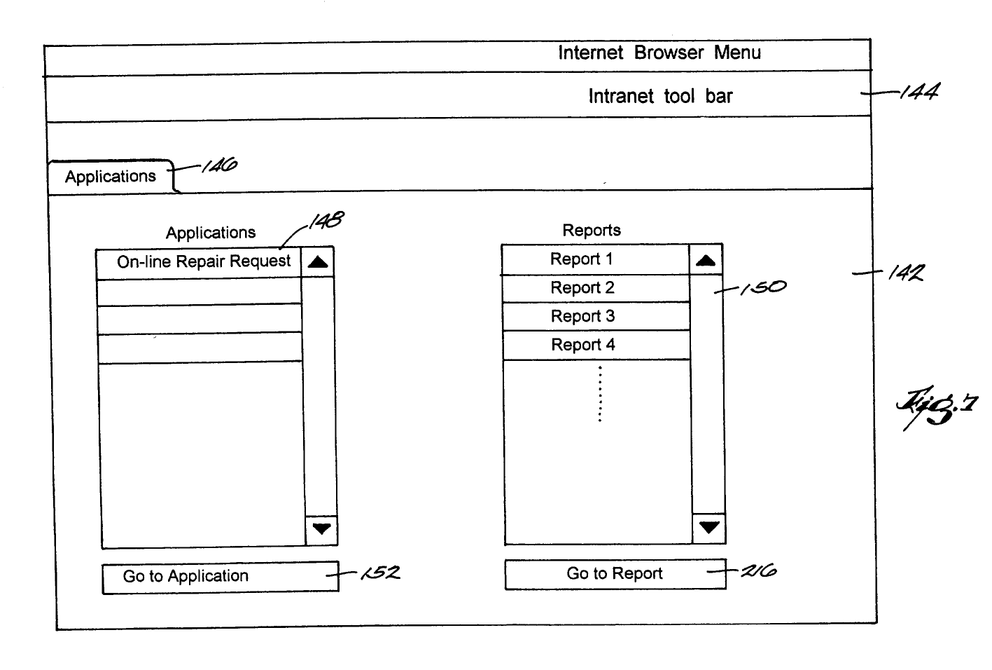

An Internet/Intranet web site 102 is created on the server 24 as a gateway to creating, modifying, and obtaining information related to work order requests and various departments within an organization. The web site 102 is accessible by the system administration terminal 12, the central office terminal 14, the shop terminal 16, the school terminal 18, and the public terminal 20. The web site 102 includes a number of web pages and other content including a web page 104, as illustrated in FIG. 5. The web page 104 includes an entity name 106, a department name 108 within the entity, and a logo 110 associated with the entity or department.

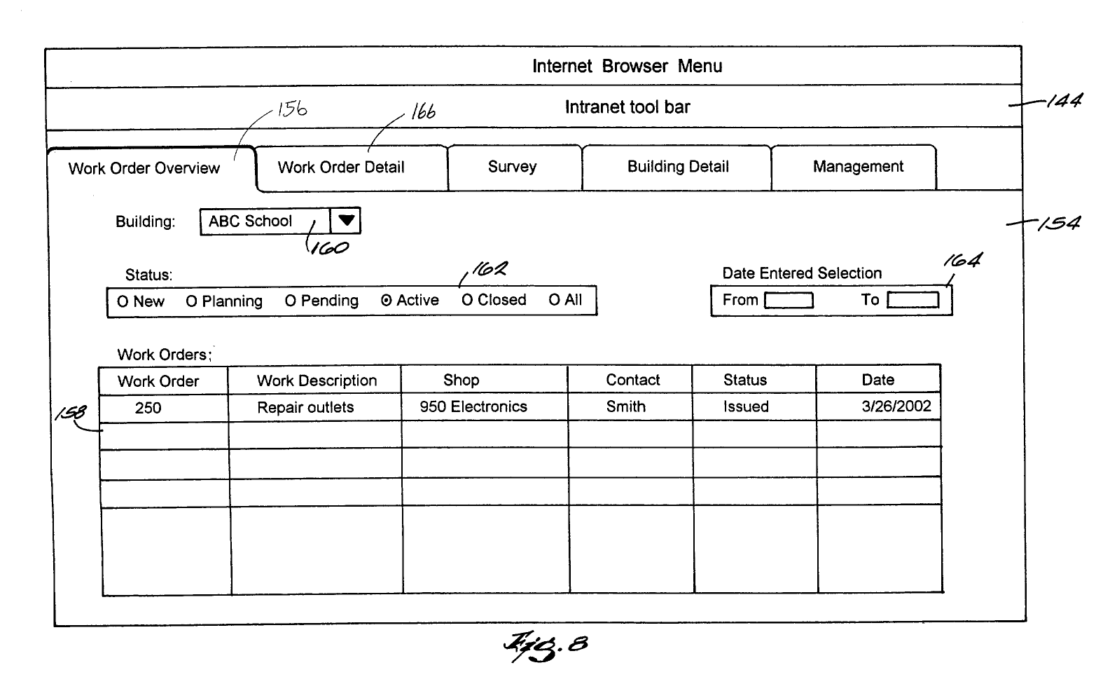

Hypertext links 112-130 are provided to access web pages containing additional information by clicking on the hypertext link with a mouse, keyboard, or similar device. The hypertext links 112-130 provide connections to a director's web page, a personnel web page, a trade services web page, a professional services web page, a census application web page, an additional information web page, an Intranet applications web page, a user's guide web page, a registration web page, and an interactive tutorial web page. The director's web page provides information on any pertinent topic as decided by the director. The personnel web page provides a list of organization management employees, as well as other employees, and the departments they manage and a description of department tasks. The trade services web page provides a listing of various shops with employees and a description of shop tasks that can be performed if requested via a work order. The professional services web page provides a list of upper level departments within the organization with employees and a description of department tasks. The census application web page provides access to the census application module 44. The additional information web page provides notices and information related to changes in the system 10. The Intranet applications web page includes a login screen 132 (FIG. 6), which acts as an access gateway to the work order request module 60 and other modules, if authorized. The user's guide web page provides a step-by-step instructional supplement to use the work order request module 60. The registration web page includes a form used to obtain a user identification and password for authorized access to the various modules of the system 10. The interactive tutorial web page provides hypertext links to additional pages containing information on entering and tracking work order requests.

The work order request module 60 is a tool for entering and tracking work order requests. As noted, the work order request module 60 is accessible via the Intranet applications hypertext link 124 on web page 104. Referring to FIG. 6, the login screen 132 is a single sign-on process. The authorized user enters a username value 134, a password value 136, and a database value 138, and clicks on a connect button 140 to activate a login processor. The login processor verifies that the username and password correspond to an authorized user and enables the user's rights and privileges to use the work order request module 60 or other modules, if authorized. This ensures that only authentic (or registered) users are allowed access to the work order request module 60 and that users are permitted access that is appropriate for their role and activity. If a user does not already have authorized access, he or she may select registration hypertext link 128 to obtain a user identification and password for authorized access to the work order request module 60. When the user exits the system, all user rights and privileges are disabled. The single sign-on is advantageous because the user cannot use a third-party tool to access the modules of the system 10.

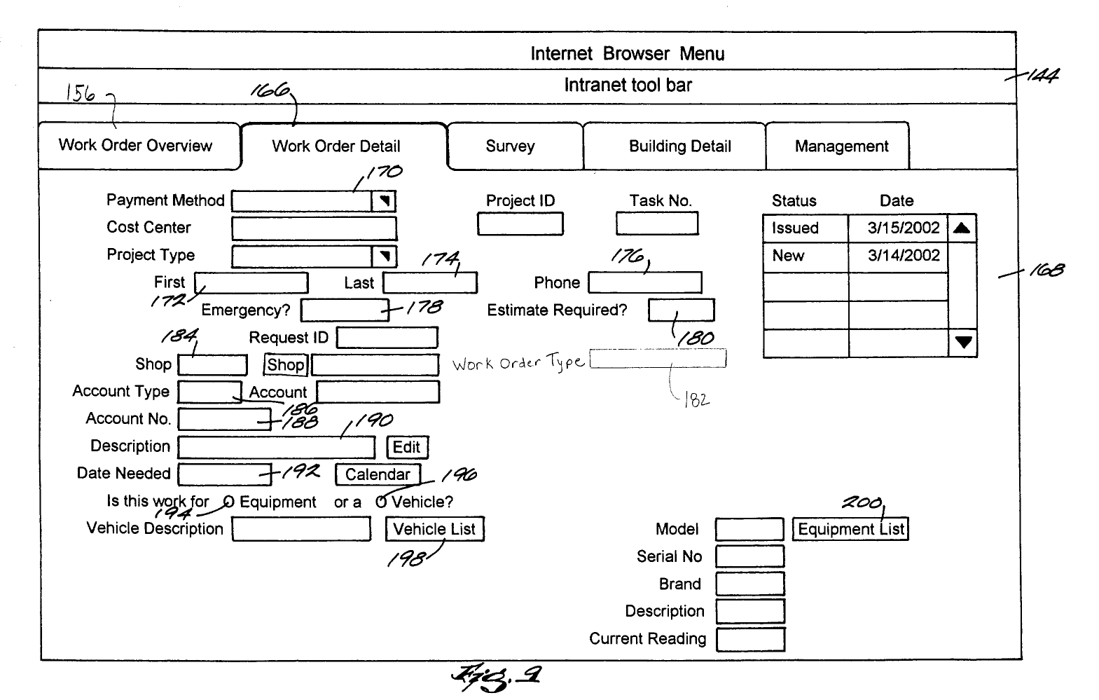

Selecting or clicking on the “Connect” button 140 causes an Intranet main menu screen 142 to appear, as illustrated in FIG. 7. The screen 142 includes a tool bar 144 containing icons or links that are shortcuts to manipulating the database 62. On an Applications tab 146, an Applications area 148 indicatess which modules the user has access to based on the user's access rights. A Reports area 150 presents the reports associated with each module. As the user selects a particular module in the Applications area 148, the Reports area 150 is updated to reflect the particular reports available.

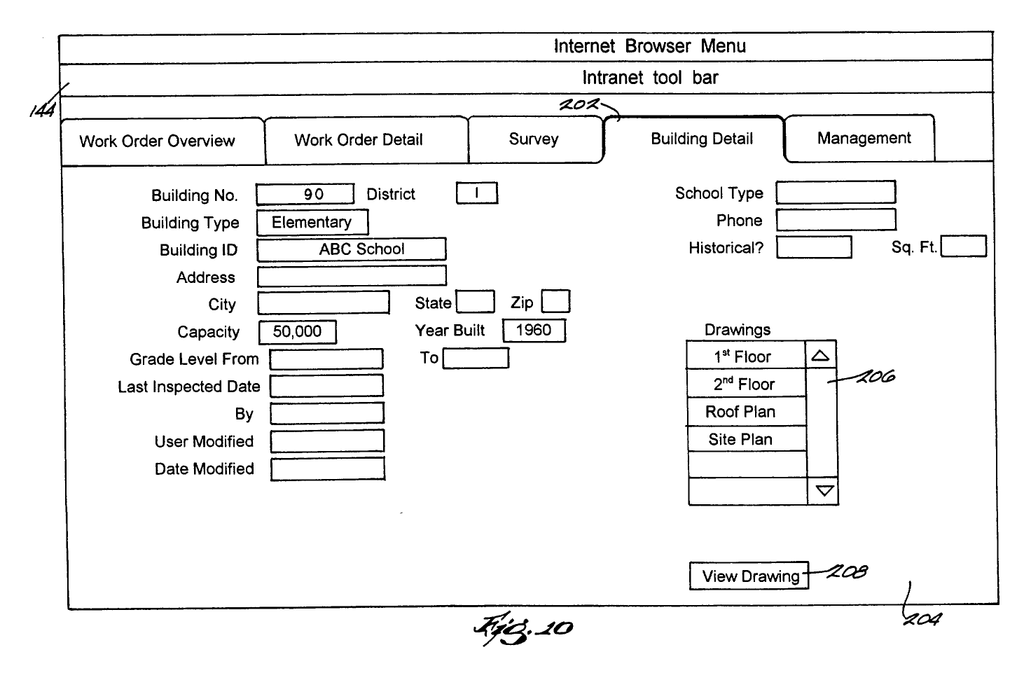

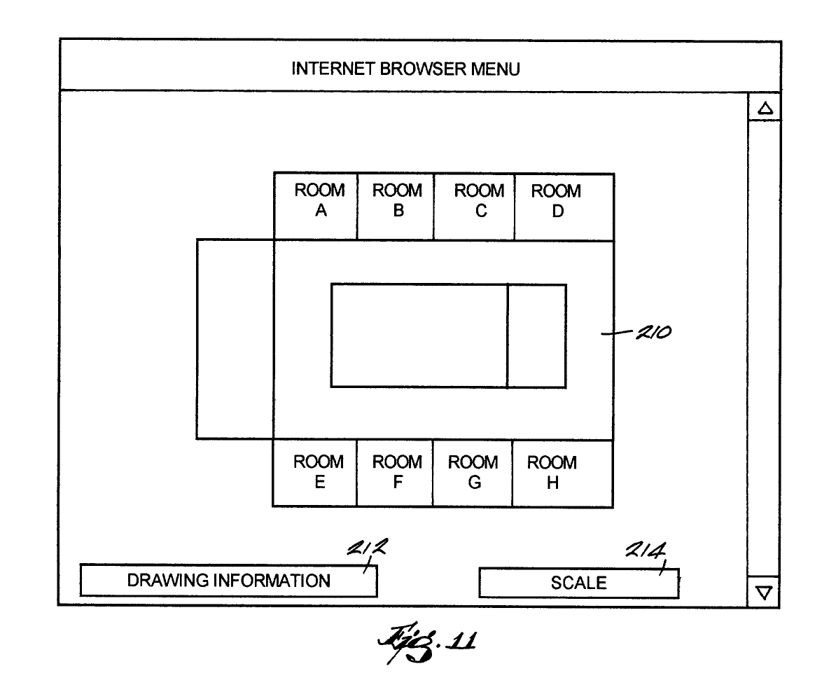

The user selects “On-line Repair Request” from the Applications area 148 and clicks on a Go to Application button 152 which causes a work order request browser menu 154 to appear, as illustrated in FIG. 8. The work order request browser menu 154 includes several tabs to assist the user in creating, searching, and modifying a work order. A work order overview tab 156 presents all of the active work orders for a particular building in a work orders area 158. The work orders for the building in which the user works is initially displayed, based on the user's access rights. The user can change the building and corresponding work orders displayed by selecting a drop-down menu in a building field 160. A status area 162 allows the user to view all work orders or specific work orders based on the work order process of new, planning, pending, active, closed, or all. The user can enter a date range in a date entered selection area 164 to view work orders during a specific time period. Each of the columns of data can be sorted by clicking on the column header.

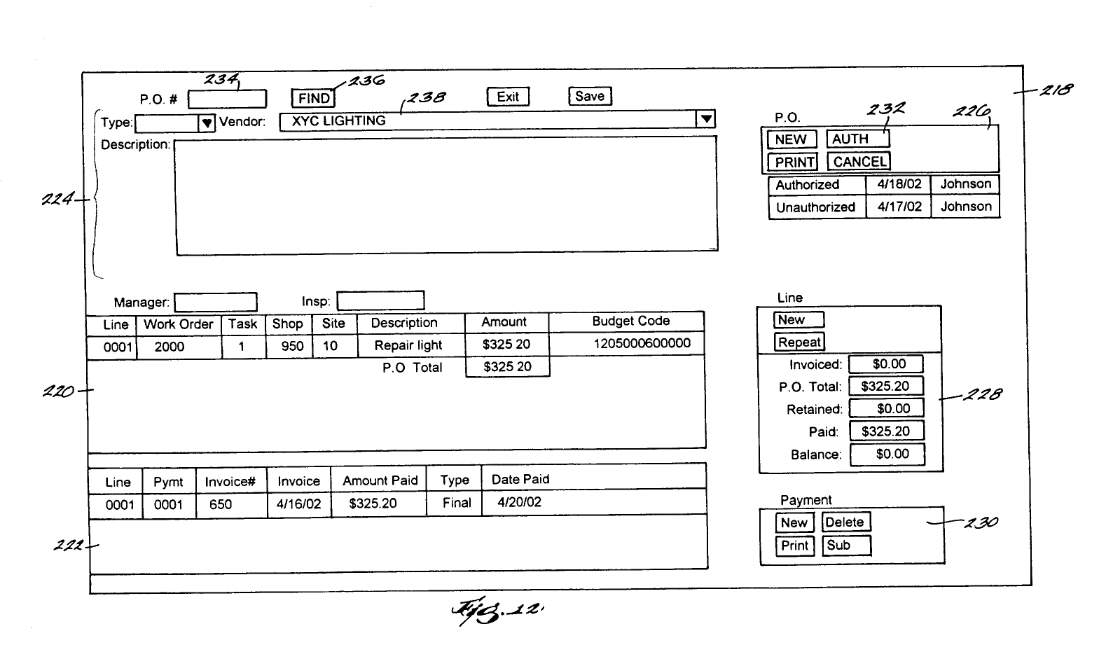

Referring to FIG. 9, the second tab of the work order request browser menu 154 is illustrated. A work order detail tab 166 illustrates a work order detail screen 168. The work order detail screen 168 displays the details of a work order and identifies the process statuses of the work order with corresponding dates. Screen 168 is also utilized to enter new work orders into the system. The user enters a new work order by clicking on an icon or link (not shown) in the tool bar 144 to insert a new record. The information fields on the screen 168 are cleared. The user then selects a payment method 170, first name of the requester 172, last name of the requester 174, and phone number of the requester 176. The user can click in a box 178 to indicate whether the work requested is an emergency. The user can click in a box 180 to indicate whether the requester needs an estimate prepared prior to work commencing. The user also enters or selects a work order type 182, a shop 184 to perform the work, account type 186 and account number 188 to indicate the account from which funds are to be withdrawn for the work services performed, a description 190 indicating the particular work being requested, and date needed 192 to indicate when the work needs to be completed. If the user is requesting the work order to repair a vehicle or piece of equipment, then the user selects an equipment radio button 194 or a vehicle radio button 196. By selecting one of the radio buttons 194, 196, the user can further select the specific vehicle from a vehicle list 198 or the specific piece of equipment from an equipment list 200. These lists 198 and 200 represent the vehicles and pieces of equipment, respectively, used in the organization. The corresponding fields, whether vehicle or equipment, are completed based on the selection from the list 198 or 200. The work order is stored in the system 10 by clicking on an icon or link (not shown) on the tool bar 144 or performing equivalent keyboard strokes to save the work order record. After the work order is stored in the system 10, it is assigned as a “new” work order, and it can be modified by the requester while the work order remains in the “new” status.

The work order is modified by the requester by selecting the work order overview tab 156 and “new” in the status area 162 (the building selection 160 defaults to the building in which the user works) in FIG. 8. The work orders still in the “new” status populate the work orders area 158. Next, the user selects the work order of interest and selects the work order detail tab 166. The work order fields may be modified or cancelled (by the creator) only if it a new status. The changes are stored in the system 10 by selecting or clicking on an icon or link (not shown) on the tool bar 144 or performing equivalent keyboard strokes to save the changes to the work order record.

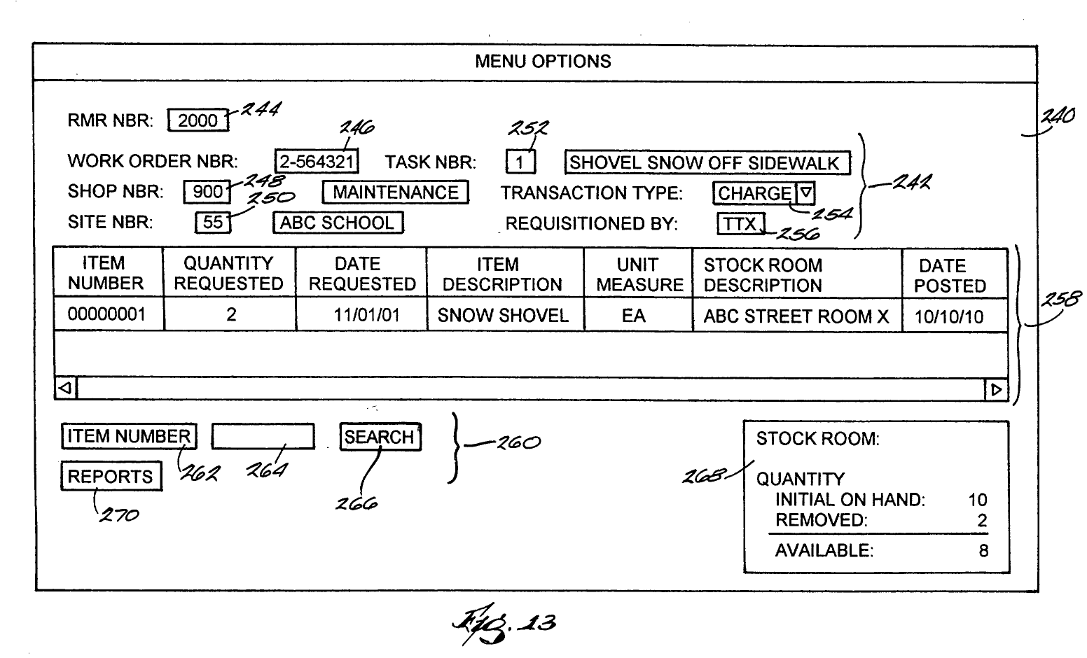

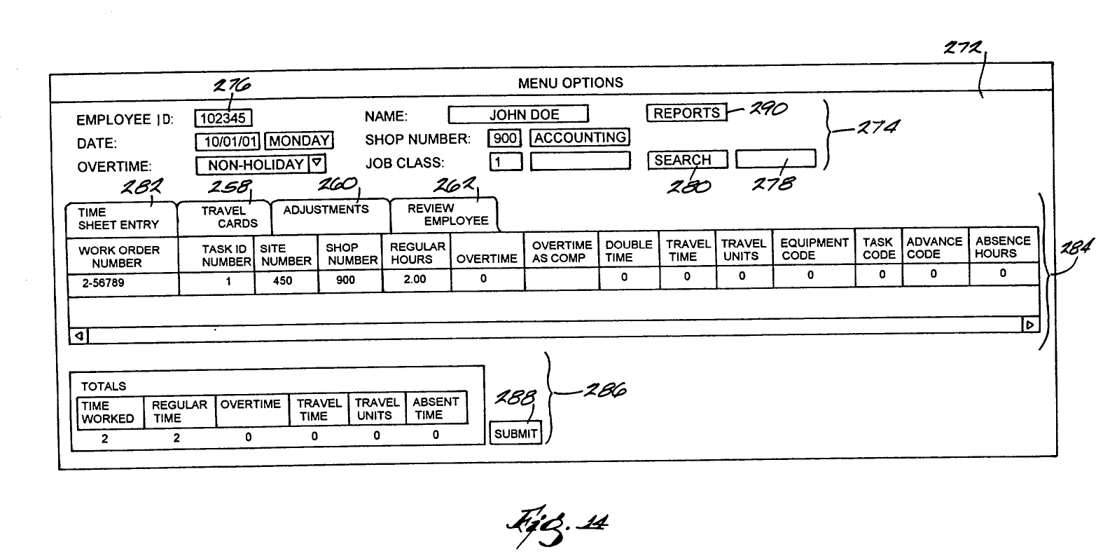

Referring to FIG. 10, the fourth tab of the the work order request browser menu 154 is illustrated. A building detail tab 202 shows a building detail screen 204. The building detail screen 204 displays detailed information of each building, e.g., floor plans, building address, etc. A drawings area 206 provides a list of floor plans for the building selected in building field 160 (FIG. 8). The user selects a particular floor plan and clicks on a view drawing button 208. A drawing 210 of the floor plan appears, for example, as illustrated in FIG. 11. The drawing 210 includes drawing information 212, such as, for example, floor level, location, address, and date of drawing. A scale 214 is also provided on the drawing 210 for reference. Reporting Module 32 The reporting module 32 queries the database 62 that stores information from any module as submitted by a user through terminals 12, 14, 16, 18, or 20 of the system 10. The reporting module 32 provides a list of preconfigured reports that complies with various department needs (i.e., daily, monthly, or yearly reports). Referring to FIG. 7, the preconfigured reports that are available for each module are presented in the reports area 150 on the Intranet main menu screen 142. The data that comprises the preconfigured reports can be filtered to include specific data. Custom reports may also be generated based on one or more fields that better fulfill the user's business needs. The reports can also be exported to other applications, such as, for example, Microsoft Office applications.

To generate a report, the user selects a report from the reports area 150 and selects or clicks on a Go to Report button 216.

Purchase Order and Credit Card Module 34

The purchase order and credit card module 34 is a tool that assists in automating purchasing and payment of materials and services needed to complete work orders. The purchase order and credit card module 34 measures costs of vendors, work orders, tasks, and accounts, and is maintained based on cost center. In particular, purchase order and credit card module 34 tracks, among other things, total invoice amount, credit amount, paid amount, unpaid balance, and variance after the purchase order is paid. The purchase order and credit card module 34 communicates with a vendor database that stores information related to a vendor, such as address, phone number, contact information, and past purchase history. The purchase order and credit card module 34 may also interface with an electronic commerce application to conduct electronic purchasing transactions. The electronic commerce application provides a selection of preferred vendors and provides a channel for submitting electronic purchase orders directly to the vendor. The electronic commerce application also provides for electronic receiving and tracking of shipment information.

The purchase order and credit card module 34 supports minority participation for major contracts and tracks the percentage of participation for compliance with minimum legal requirements where participation of minority-owned firms is required. The purchase order and credit card module 34 may interface with a purchasing card application for automatic tracking of payments and purchases made with a credit card. If vendors require access to any of the organization's buildings, the purchase order and credit card module 34 tracks building access keys that are provided to the vendors. Furthermore, the tracking function allows final payment to be withheld until all keys supplied to the vendor are returned. The purchase order and credit card module 34 is integrated with the work order module 30, the materials and inventory module 36, the commitment of money module 52, and the automatic identification module 56.

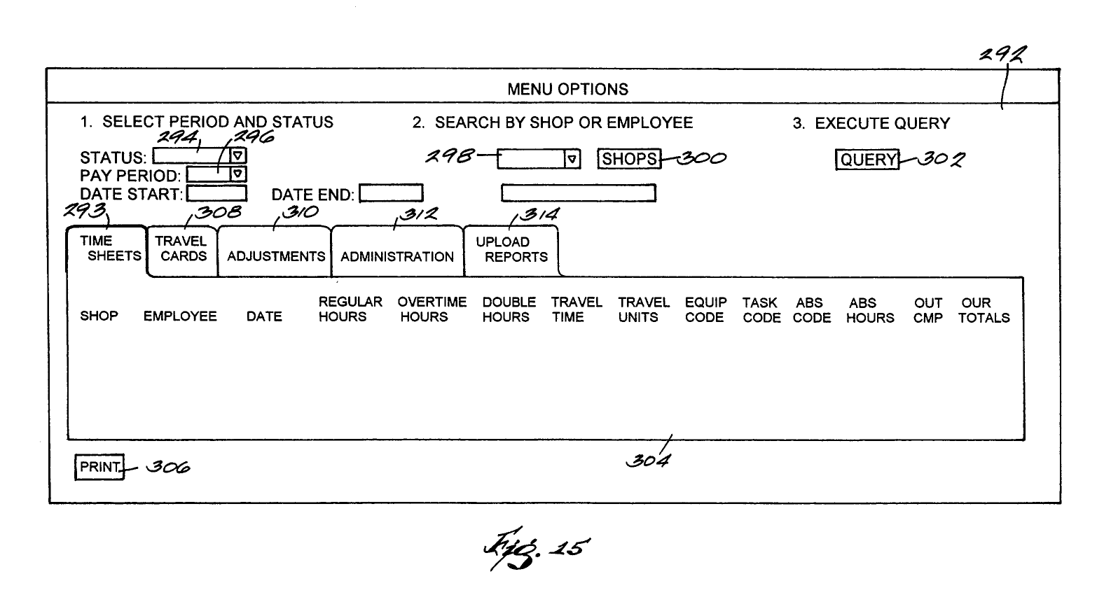

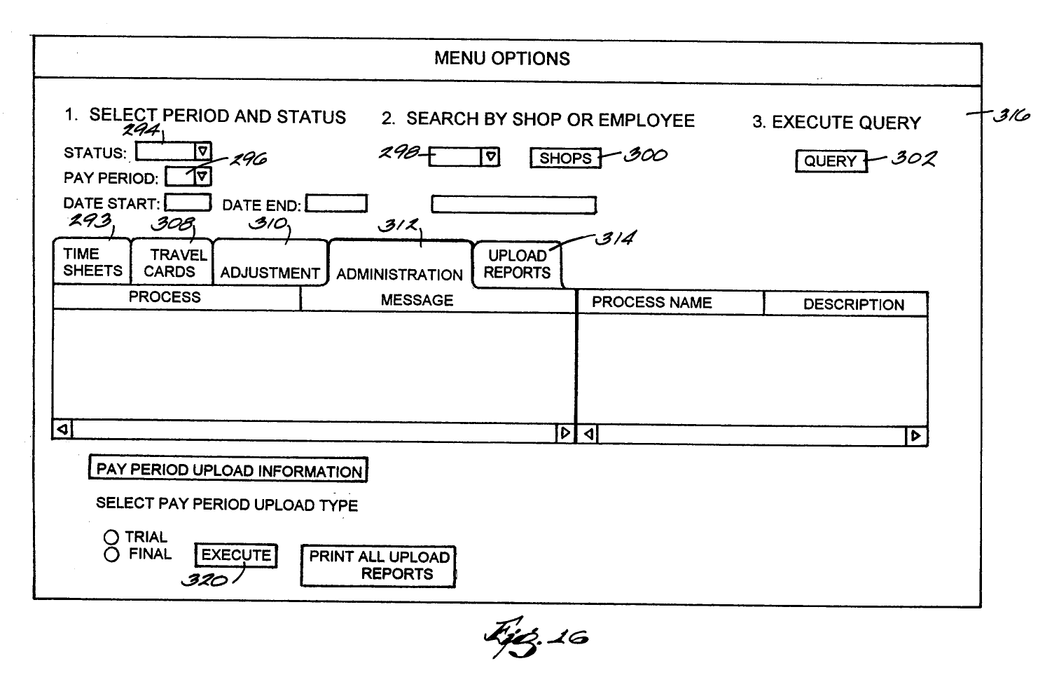

As noted, the purchase order and credit card module 34 is accessed by selecting or clicking on icon or link 70 on screen 64 (FIG. 2). As illustrated in FIG. 12, a purchase order screen 218 displays several areas that maintain the history of work performed and history of payment of the work performed for a purchase order. A billing area 220 illustrates the costs/billing information of work performed for each work order on the purchase order. A payment description area 222 shows the payment details for the work performed/bills. An information area 224 shows the vendor that performed the work and description of the work requested to be performed. A purchase order area 226 allows a user to generate a new purchase order, authorize, print and cancel a purchase order. A summary area 228 maintains the history of billing and payment information. A payment area 230 allows a user to generate a new payment, print, delete, or track sub-contractor payments.

After the purchase order is stored in the database 62, it needs to be authorized for payment. A user with access to the purchase order and credit card module 34 selects an authorization button 232 for a particular purchase order. An authorization processor authorizes the purchase order for payment. After the authorization process is complete, funds are charged to the commitment of money module 52 (discussed below) for the purchase order and payment is released (partial or final). If a purchase order requests an item that is stored in the organization's inventory, the purchase order and credit card module 34 communicates with the materials and inventory module 36 (discussed below) to complete the purchase order by adding the item(s) to inventory.

The purchase order and credit card module 34 includes a search engine for locating preexisting purchase orders. The user can enter a purchase order number in a P.O. # field 234 and select a find button 236 to initiate a search. An alternative method of searching for a purchase order(s) is by selecting a particular vendor from a drop-down menu of a vendor field 238 in the information area 224. All of the purchase orders relating to a particular vendor appear in the billing area 220.

Materials and Inventory Module 36

The materials and inventory module 36 provides a tracking system or mechanism for maintaining inventory records. Each item of inventory is given a unique tag, preferably a bar code, to automate order processing, receiving, and product selection from vendors. The materials and inventory module 36 tracks, among other things, availability, quantity, requisition costs, and item location. When inventory is low for an item, the materials and inventory module 36 communicates with the purchase order and credit card module 34 to automatically generate a purchase order for the item. Stock room personnel update the materials and inventory module 36 as new inventory is received.

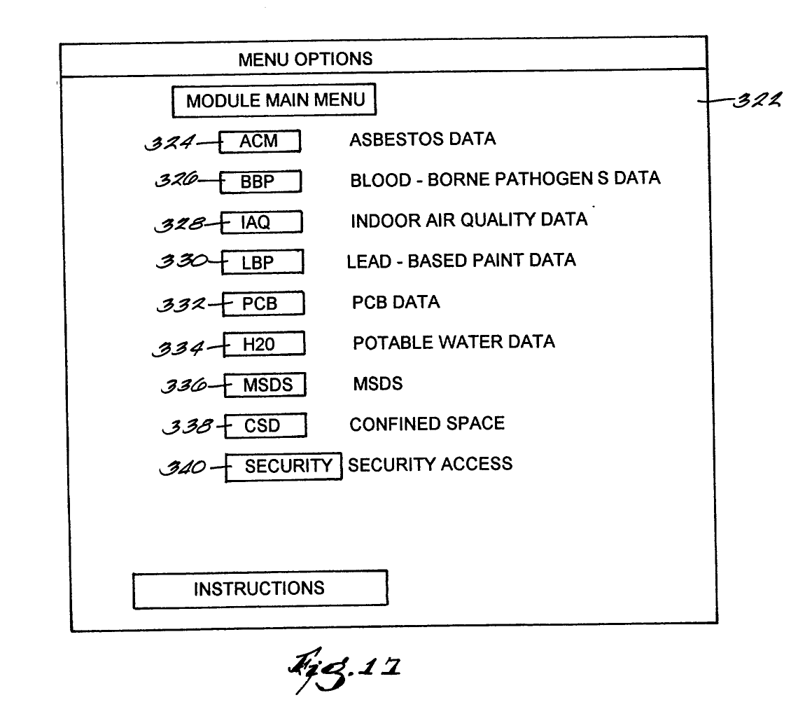

The materials and inventory module 36 includes a search engine to identify inventory quantity and determine inventory location. The materials and inventory module 36 is accessed by selecting or clicking on icon or link 72 on screen 64 (FIG. 2). The materials and inventory module includes an inventory request screen 240, illustrated in FIG. 13. The screen 240 includes a main information area 242 that provides information about the work order for which an item is needed. The main information area 242 has a Repair Materials Requisition (“RMR”) number value 244, a work order number value 246, a shop number value 248, a site number value 250, a task number value 252, a transaction type value 254, and a requisitioned by value 256. In the embodiment shown, the RMR number value 244 is a unique identifier for one or more items related to a work order; the work order number value 246 is an assigned work order number from the work order request module 60; and the shop number value 248 is the shop number of the shop requested to perform the work entered on the work order detail screen 168 of the work order request module 60. A description of the shop number value 248 is also provided. In the embodiment shown, the site number value 250 is the number of the building/location where the work is needed as selected on the work order overview tab 156 of the work order request module 60. A description of the site number value 250 is also provided. In the embodiment shown, the task number value 252 is an assigned number given to separate tasks that are required to be performed to complete a work order. A description of the task number value 252 is also provided. The transaction type value 254 is selected from a pull down menu to indicate how the requisition of an inventory item is paid. In the embodiment shown, the requisitioned by value 256 is the initials of the person searching for or requisitioning an inventory item.

A detail section 258 provides detailed information of an inventory item, including among other things, item number, item description, unit of measure, stockroom location, and date posted (date entered into inventory). A search section 260 provides access to a search engine to locate an inventory item. The search section 260 is not accessible until all information in the main information area 242 is completed. A search category value 262 is selected by a drop down menu. In the embodiment shown, the search category value 262 is an item number or a description. The item number or description is entered into a blank field 264 next to the search category value 262. A search button 266 activates the search engine. A portion of the item number or description may also be entered, and the search engine lists all items that begin with that item number or description in the detail section 258. Initially, the detail section 258 does not display a value for quantity requested or date requested. An item of inventory is requisitioned by entering an amount into the quantity requested field and a date in the date requested field in the detail section 258. A summary section 268 provides item quantity in stock information. When an item of inventory is requisitioned as indicated above, the summary section 268 is updated to reflect the number of those items remaining in stock.

A reports button 270 on inventory request screen 240 causes the module 36 to generate stock history information. In the embodiment shown, the reports button 270 causes a search engine to review stock transaction history by one of the following categories: shop, requisitioner, work order number, RMR number, date requested or all categories.

Employee Resource Module 38

The employee resource module 38 is a paperless employee information and measurement system. The employee resource module 38 is operable to access and process information related to personnel training and skills, certifications, continuing education courses, accumulation of regular, overtime, and double-time hours spent on a task, travel time, absences and reasons therefor, vacation hours, emergency contact information, badge and bar code information, cell phone, credit card, key identification, pager and computer information, and security access level to the system 10.

The employee resource module 38 tracks employee attendance at continuing education courses, seminars, training, etc. The employee resource module 38 provides for automatic tracking of attendees through use of multimedia/video on-line training, such as Intranet presentations. Conferences and seminars can be broadcast through the network 23 and attendees are automatically identified and entered in the database 62 and other records associated with the employee resource module 38.

Time Sheet Entry Module 40

The time sheet entry module 40 is designed to facilitate entry of labor transactions related to payroll. Each employee enters time and attendance information into the system 10 using the time sheet entry module 40. The employee may enter information using a computer terminal, computerized handheld device, or other device with access to the network 23. An employee's labor hours are coded to a specific task or work order. While an employee is entering data into the system 10, the data is validated to the work order such that the time entered does not exceed the time actually worked on a work order. This electronic time sheet eliminates the numerous paper records and time cards, and it provides an electronic audit trail for future review as needed.

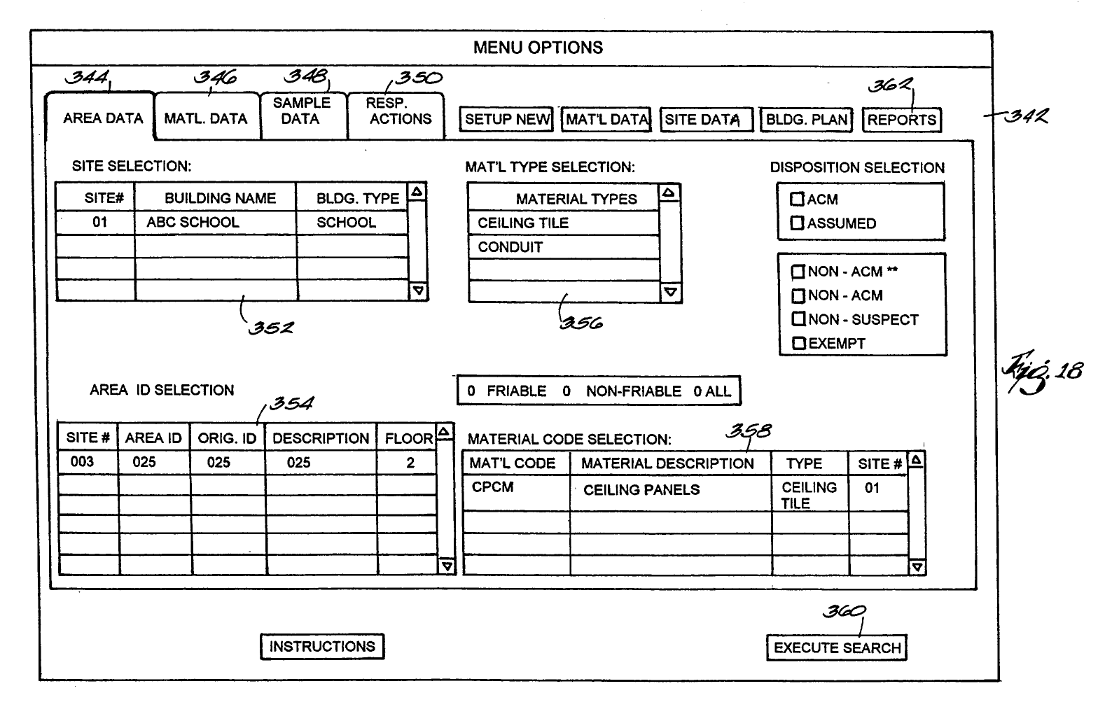

The time sheet entry module 40 is accessible by selecting or clicking on the icon or link 76 on screen 64. A time sheet entry screen 272 is illustrated in FIG. 14. The screen 272 includes a main information area 274 for entering information about the employee. In the embodiment shown, an employee identification value 276 is the number assigned to the employee by the organization. The employee identification value 276 is entered to view information about the specific employee. The main information area 274 also supports a search engine to locate the employee identification value 276. A search can be performed by entering an employee's last name in blank field 278 and clicking on a search button 280.

The time sheet entry screen 272 includes multiple tabs. A time sheet entry tab 282 includes a detail area 284 for entering information related to hours worked, absences, travel, and adjustments to previous entries. After entering data in the main information area 274, an employee can enter the number of hours worked, including regular, overtime, or double time, travel time, and absent time in the detail area 284. A summary section 286 provides a summary of the information entered in the detail area 284. A submit button 288 transmits the entered information to the network 23 for payroll processing (discussed below).

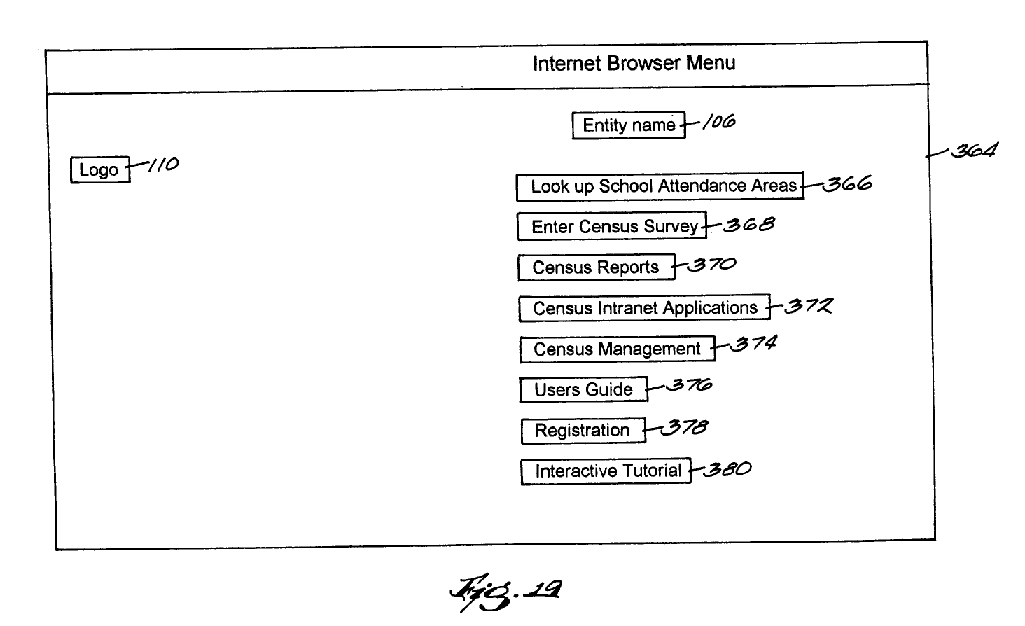

Time sheet entry reports can be generated by selecting a reports button 290. The reports include information regarding present and past pay periods for employees. A time sheet entry report screen 292, illustrated in FIG. 15, appears. The screen 292 includes several tabs and numerous dialog boxes to enter search parameters. A time sheets tab 293 includes a status value 294, a pay period value 296, and a search by shop or employee value 298, all of which may be selected from drop down menus. In the embodiment illustrated, the start and end dates are automatically entered based on the selected pay period value 296. If a search for employee or employees by shop is preferred, a shops button 300 may be selected to access a menu of all available shops. The shop description is automatically entered based on the selected shop. Clicking on a query button 302 begins the search. Based on the search criteria, labor related data (e.g., hours worked, travel time, absences, etc.) of an employee or multiple employees appears in a detail section 304. The report can be printed by clicking on a print button 306.

The time sheet entry report screen 292 also includes a travel cards tab 308, an adjustments tab 310, an administration tab 312, and an upload reports tab 314.

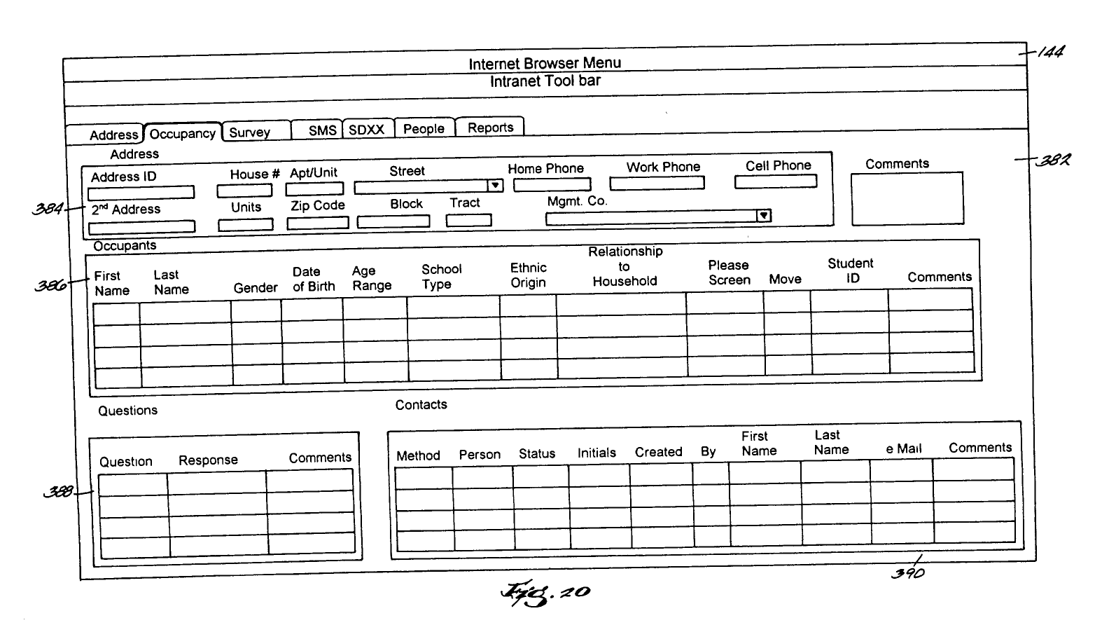

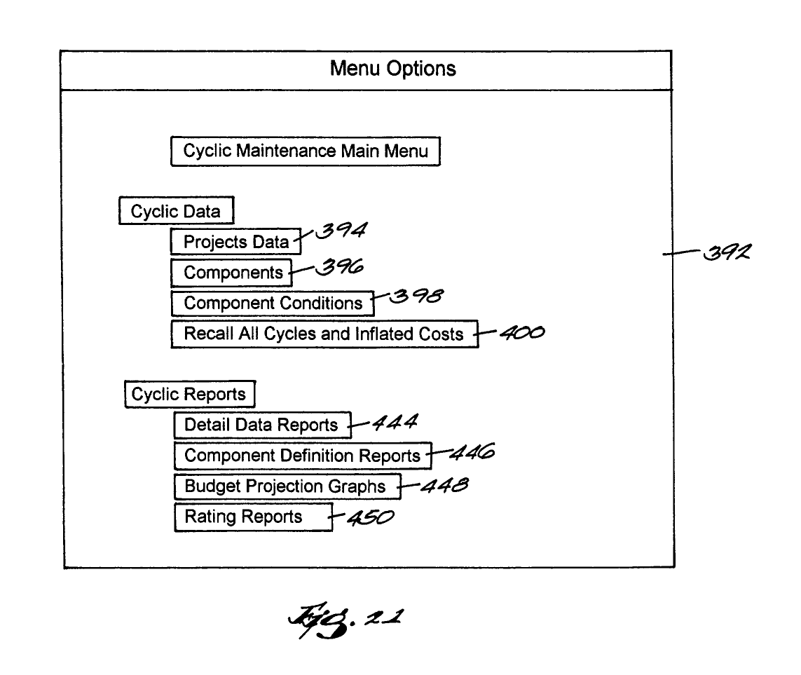

Payroll processing begins at the time sheet entry report screen 292. A similar report is generated as described above, however, the status value 294 selected is “on hold.” In the embodiment shown, “on hold” indicates that the information has not been processed through payroll. Selecting or clicking on the query button 302 begins the search. Time sheet entry data with an “on hold” status appear in the detail section 304. The user then selects the administration tab 312. Referring to FIG. 16, the administration tab 312 illustrates a payroll screen 316. By selecting or clicking on an execute button 320, time sheet data entries are tested (trial) or uploaded (final) for payment of employees for work performed (e.g., issuing a payroll check).

Environmental Data Management Module 42

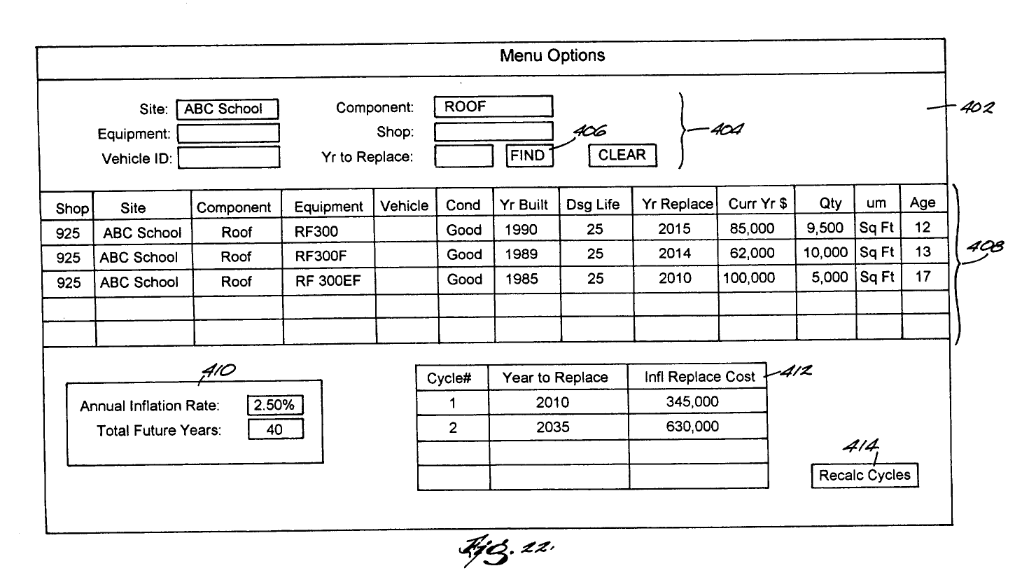

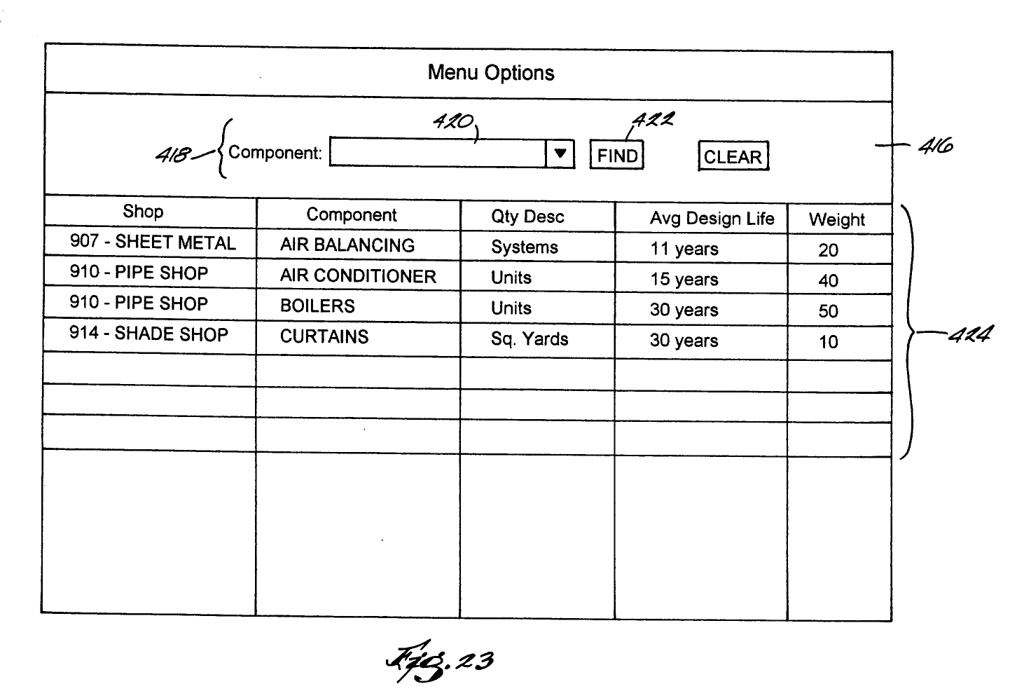

In the embodiment illustrated, the environmental data management module 42 includes an information database for the tracking, removal, inspection, and management of the environment within the organization. The environmental data management module 42 is accessible by selecting or clicking on the icon or link 78 on screen 64 (FIG. 2). FIG. 17 illustrates an environmental menu screen 322 including an asbestos data button 324, blood-borne pathogens data button 326, indoor air quality data button 328, lead-based paint data button 330, PCB data button 332, potable water data button 334, material safety data sheet button 336, confined space button 338, and security button 340. The asbestos data button 324 provides a link to an asbestos search screen 342 illustrated in FIG. 18.

The asbestos search screen 342 includes tabs 344-350. The area data tab 344 provides a search engine to locate whether asbestos is present in a particular location and within a specific building material. A site selection area 352 provides a list or record of all the buildings within the organization. Clicking on a particular building in area 352 populates the remaining areas of data. Particular areas within a building can be searched for the presence of asbestos by selecting a room or multiple rooms in an area identification selection section 354. A material type selection section 356 and a material code selection section 358 are used to select specific building materials for the presence of asbestos. Clicking on an execute search button 360 initiates a query to identify information that satisfies the search criteria.

Environmental data can be added, updated, or deleted in the environmental data management module 42 by authorized personnel. Information in the environmental data management module 42 can be viewed by other users of system 10, but is in a read-only format.

The environmental data management module 42 also has a report generator to generate preconfigured and customized reports by clicking on a reports button 362.

Census Application Module 44

In the embodiment illustrated, the census application module 44 is an information tracking system that provides the location of children in the city or municipality in which the organization is located based on a census performed by the municipality, organization, or other government authority. The census information is analyzed to determine present and future attendance information for schools in the organization, future planning, future costs, as well as other information. The census information also provides strategic planning of where, when, why, and how costs are incurred in the organization. The census application module 44 may be configured to communicate to a city database 25 (illustrated in FIG. 1A) maintained by the city in which the organization is located. The census application module 44 compares the organization's census information with the city database 25. When so configured, the census application module 44 communicates with the city database 25 over a secure network connection utilizing a secure software application, preferably Oracle Spatial software. The city database 25 maintains map information of the city (e.g., addresses of buildings, schools, houses, and other landmarks). Each building, school, house and landmark is assigned a unique address for census and tracking purposes. This information is used by the census application module 44 to determine the locations of where children live.

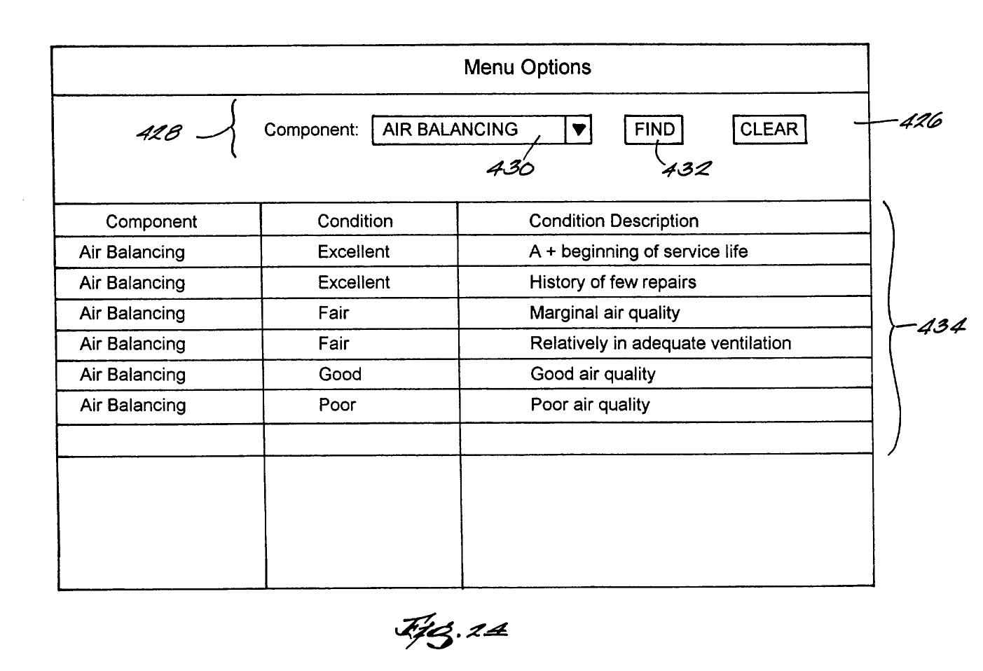

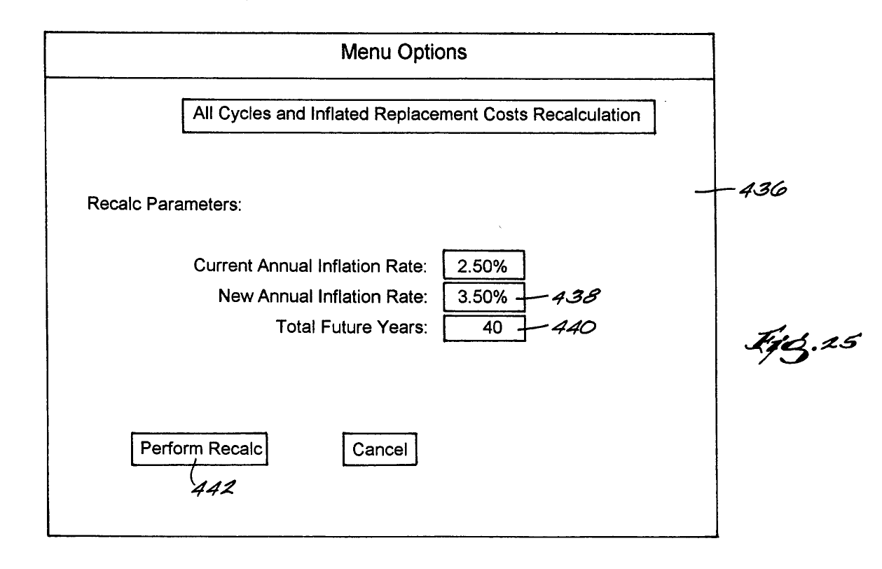

The census application module 44 includes various data entry and lookup screens to perform a census. The census application module 44 is accessible by selecting or clicking on the icon or link 80 on screen 64 (FIG. 2). Alternatively, the module 44 is accessible by selecting or clicking on the hypertext link to the census application page 120 (FIG. 5). FIG. 19 illustrates a census information web page 364. This page 364 provides hypertext links 366-380 to a school attendance areas page, an enter census survey page, a census reports page, a census Intranet applications page, a census management page, a user's guide for census applications page, a registration for census application page, and an interactive tutorial for the census applications page. The school attendance areas hypertext link accesses a page that identifies the school attendance areas per entered address or address range (schools available where a student lives). The enter census survey hypertext link 368 accesses a page which allows for manual entry of a mailed census survey. The census reports hypertext link 370 accesses a page which allows for the generation of preconfigured census reports. The census Intranet applications hypertext link 372 provides access to a census data entry screen 382 (FIG. 20) for direct entry of census information. The census management hypertext link 374 accesses a page used by select personnel in the organization to assign a unique address to each building, school, house, and landmark, and to perform census administration functions, e.g., set up enumerators or census data entry personnel, year-end processing, and run status reports. The user's guide for census application hypertext link 376 accesses a page which provides step-by-step instructions on how to use the page accessed by the census Intranet applications hypertext link 372 and identifies the information that is entered in each field. The registration for census applications hypertext link 378 accesses a page where unauthorized personnel can request a registration identification to use the census application module 44 and to access the breadth of information collected in this module 44. The interactive tutorial for the census applications hypertext link 380 accesses a page which provides hypertext links to additional pages containing information on using the census application module 44.

The census data entry screen 382 is illustrated in FIG. 20. An address information section 384 maintains the address of the dwellings in the city. Edit checks are performed to ensure that dwellings are not duplicated. An occupants information section 386 provides detailed information (e.g., name, gender, date of birth, school type, ethnic origin, relationship to household) of the occupants residing in the dwelling. A questions section 388 identifies questions to ask the occupants and the response of the occupants. A contacts section 390 identifies other persons contacted or interviewed to obtain the necessary information to complete the census survey. A census worker may go door-to-door to obtain this information and directly enter the information via a hand-held device or other similar device. Alternatively, the census worker may mail a survey to a city resident and manually enter the data of the completed survey into the system 10 as described above.

Cyclic Maintenance Module 46

The cyclic maintenance module 46 maintains information of replacement needs of primary components throughout the organization. This module 46 provides the organization with a proactive and long range approach to major maintenance projects and determines over time when projects need to be considered. Each major maintenance project is catagorized into type of component (e.g., playground, building, parking lot), facility location, unit measurement, current condition, year of original installation, current age, average design life, projected year of replacement, and projected cost of replacement.

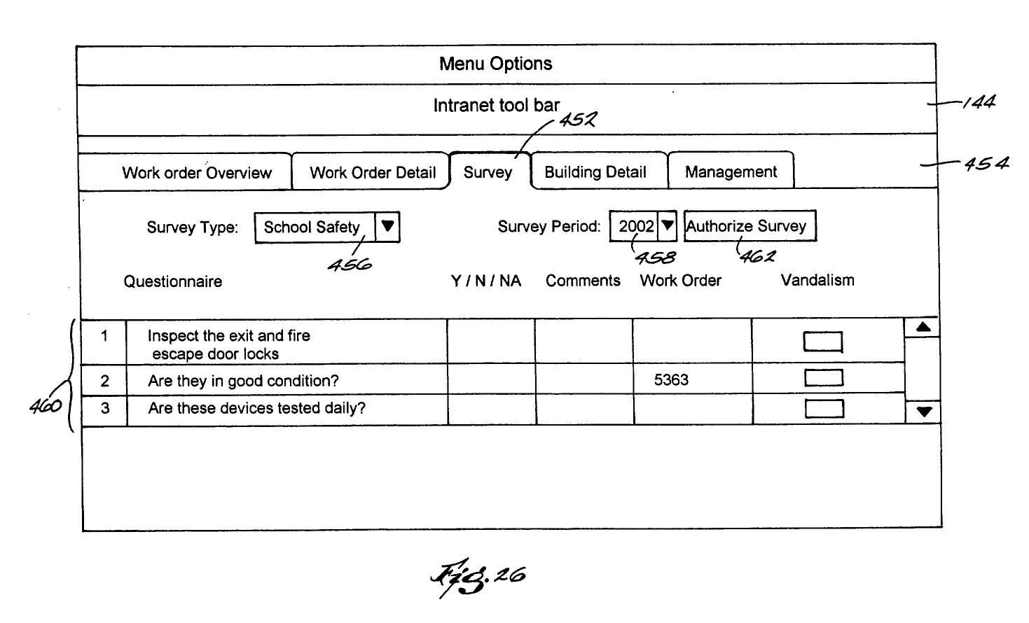

The cyclic maintenance module 46 is accessible by selecting or clicking on the icon or link 82 on screen 64 (FIG. 2). FIG. 21 illustrates a cyclic maintenance main menu screen 392. The options under “Cyclic Data” allow the user to search, display, and update projects, project cycles, components, and component condition information. The user clicks on any of the menu links 394-400 to access the screen for that link. Inflated replacement costs can be recomputed using a current inflation rate by using the “Recalc All Cycles and Inflated Costs” link 400.

FIG. 22 illustrates a projects data screen 402. The user enters search criteria in a search section 404. The user can search by site, equipment, vehicle identification, component, shop, and year to replace. After entering the search criteria, the user selects a find button 406. The results of the search are presented in a results section 408. An inflation rate area 410 identifies the annual inflation rate and total future years values used to calculate the replacement cost at the inflation rate. Replacement costs are presented in a cost section 412. Each of the data records can be edited by selecting a particular box for modification. After editing the data record(s), updates may be programmed to occur automatically or the user may select a recalc cycles button 414 to update the data to reflect the changes.

FIG. 23 illustrates a components data screen 416. The components data screen 416 allows the user to find, add, update and delete cyclic component records. A search section 418 allows the user to select a specific component from a component drop-down menu 420. The user can also retrieve all components by leaving the component drop-down menu 420 blank and selecting a find button 422. A results section 424 provides the component data based on the search criteria. The component data includes a shop indication, the component name, a quantity description, an average design life, and a weight. Additional information could also be provided. Each of the data records can be edited by selecting a particular box for modification.

FIG. 24 illustrates a component conditions data screen 426. The component conditions data screen 426 allows the user to find, add, update and delete cyclic component records used to generate component definition reports (discussed below). A search section 428 allows the user to select a specific component from a component drop-down menu 430. The user can also retrieve all components by leaving the component drop-down menu 430 blank and selecting a find button 432. A results section 434 provides the component data based on the search criteria. The component data includes a component name, a component condition, and a condition description. Additional information could also be provided. Each of the data records can be edited by selecting a particular box for modification.

FIG. 25 shows a recalculate inflated costs screen 436. This screen 436 allows the user to recalculate all inflated replacement costs using a new inflation rate for all of the primary components that are tracked in this module 46. The user enters a new annual inflation rate value 438 and a total future years value 440 and may select or click on a perform recalc button 442.

A detail data reports link 444, under “Cyclic Reports” provides a screen (not shown) to generate a detail data report including information on cycle one project records, which includes the year-to-replace and inflated replacement cost of the first cycle of each project selected for the report.

A components definition reports link 446 provides a screen (not shown) to generate a components definition report including objective and subjective information for each of the primary components throughout the organization. A percentage of each component is categorized into a particular condition that describes its current condition. The projected cost of replacements by year and the projected number of replacements by year is also provided in the report.

A budget projection graphs link 448 provides a screen (not shown) to generate a budget projection graph having a visual indication of the maintenance department budget compared to the costs of primary components repairs and/or replacements by year.

A rating reports link 450 provides a screen (not shown) to generate a rating report presenting a calculated rating for each component at a particular site. The calculated rating represents a numerical value that takes into consideration the component condition and a weighting factor that prioritizes components in terms of importance and cost. A grade for each site is also calculated as a percentage of the sum of all ratings over the maximum rating sum possible.

Image Viewer Module 48

The image viewer module 48 is a software application, preferably VoloView software, that is installed on the terminals 12, 14, 16, 18, and 20. The image viewer module 48 is utilized in conjunction with the work order request module 60 to view the drawings 210 (as illustrated in FIG. 11) of floor plans to assist in identifying the location of equipment or other items associated with a work order.

Setup and Security Module 50

The setup and security module 50 maintains an authoriziation list of which users of terminals 12, 14, 16, 18, and 20 have authorized access to use the system 10 and its individual modules.

Commitment of Money Module 52

The commitment of money module 52 provides budget information. The commitment of money module 52 distributes funds for work performed on work orders and materials purchased for completion of a work order and associated tasks. The commitment of money module 52 tracks the amount of funds already distributed and the amount remaining. An accurate balance is maintained because costs related to the work order (e.g., purchase orders, labor hours, etc.) are subtracted from the funds remaining amount. Various reports based on the tracked funds may be generated by the module 52. For example, once 80% of the committed funds are depleted, the user may input a request for the commitment of money module 52 to generate a report showing a percentage of funds expended to date. When 100% of the committed funds are depleted, costs related to the work order(s) are not posted until additional funding sources are allocated for these costs.

Automatic Identification Module 56

The automatic identification module 56 provides a unique tag to moveable and non-moveable items that may be used in an organization. Use of the unique tags (such as bar code tags, RF tags, etc.) provides an efficient tool that maintains data integrity of the system 10 by reducing the chances for data entry error. The module is operable to communicate with a printing device of machine-readable codes and a decoder of machine-readable codes. Preferably, the code is a code stored in a bar code, but could be a code in an RF tag. In the embodiment discussed, both moveable and non-moveable items have a bar code (e.g., buildings, vehicles, work orders, inventory items, purchase orders, employee identification cards, and equipment). The inclusion of a bar code on the moveable and non-moveable items allows for ease of data entry and integrity of data in the system 10. A bar code is scanned using any bar code decoder that is commonly used in the art and is automatically entered into any data entry field for which there is a bar code on any screen of the system 10.

The automatic identification module 56 is integrated with the purchase order and credit card module 34 to automate order processing, receiving, and product picking from vendors. The automatic identification module 56 records mobility of inventory, automatically updates on-hand quantities, produces purchase order requisitions, searches warehouses and stockrooms for inventory availability, automatically posts financial data and markup costs to the correct shops and accounts, and receives items with on-line verification with planned receipts and returns.

The automatic identification module 56 is integrated with the employee resource module 38. Employee identification cards are bar coded for automatic employee database entry for all trackable items such as time and attendance, training and education courses, etc. Use of a bar code as an employee identification number instead of the employee social security number is secure in that the system 10 requires a unique password assigned or chosen to each employee.

Fire Prevention and School Safety Module (“SSS”) 58

In the embodiment shown, the fire prevention and school safety module 58 is integrated to the work order module 30. In the preferred embodiment, safety items are associated with items on each work order. The fire prevention and school safety module 58 generates safety evaluation checklists, based on the cyclical plan for a primary component, electronically for the engineers of each building within the organization. The safety evaluation checklists are lists of preventative maintenance items that need to be performed on a regular basis to provide a safe environment. The fire prevention and school safety module 58 is integrated with the work order request module 60 to automatically generate work order requests for preventative maintenance that needs to be performed. The safety evaluation checklist is updated with the status of the work order, and the school engineer is notified of the update.

Referring to FIG. 26, the third tab of the the work order request browser menu 154 is illustrated. A survey tab 452 shows a survey screen 454. The user selects a survey type 456, e.g., school safety, and a survey period 458. The engineer, maintenance worker, or shop worker reviews the building to ensure that safety mechanisms are in place and then completes the survey by answering safety questions in a questionaire section 460. In the embodiment shown, the survey includes yes or no questions. The engineer or maintenance worker enters a yes or no to the questions and can also provide comments. There is also a location that provides a work order number associated with a work order request for a particular item included in the survey. The engineer or maintenance worker then authorizes the survey by selecting an authorize survey button 462.

Data Model 500 of the System 10

In the embodiment illustrated, the system 10 relies on a relational database. A relational database includes two or more tables and a set of definitions that describe the relationships between the tables. Relational databases are normalized or organized in such a way that redundancies are removed or limited.

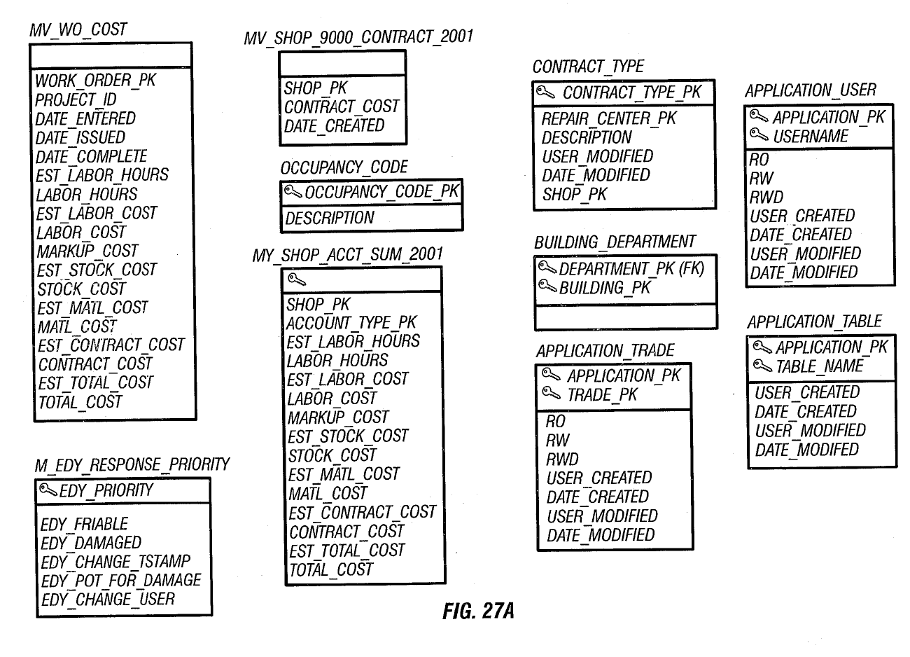

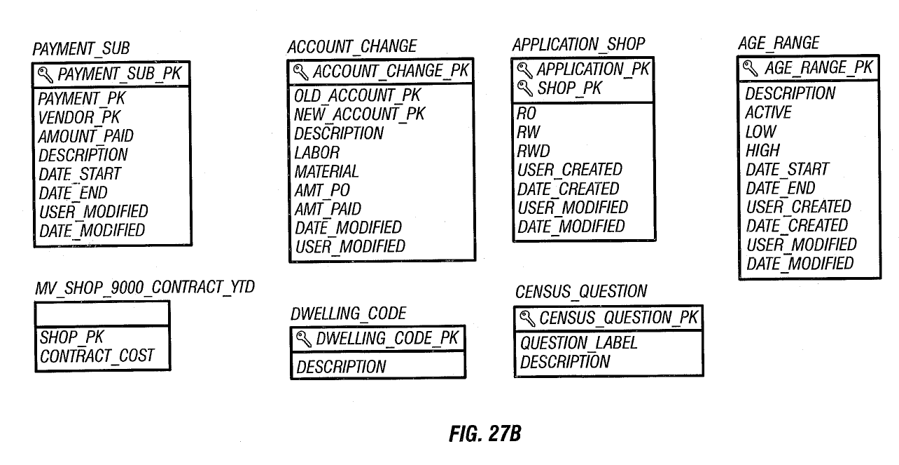

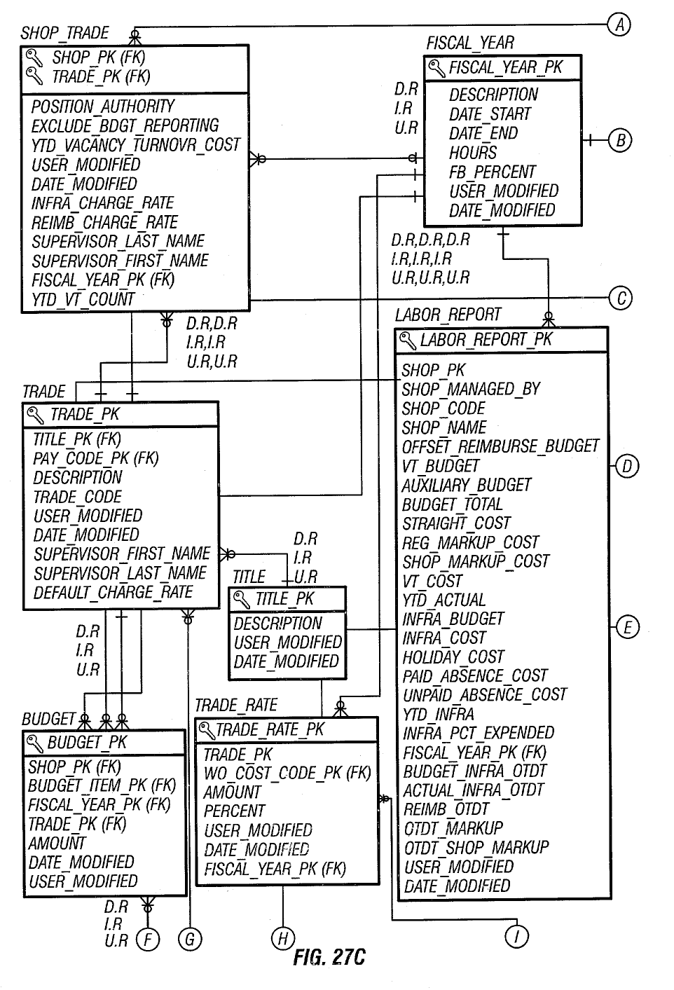

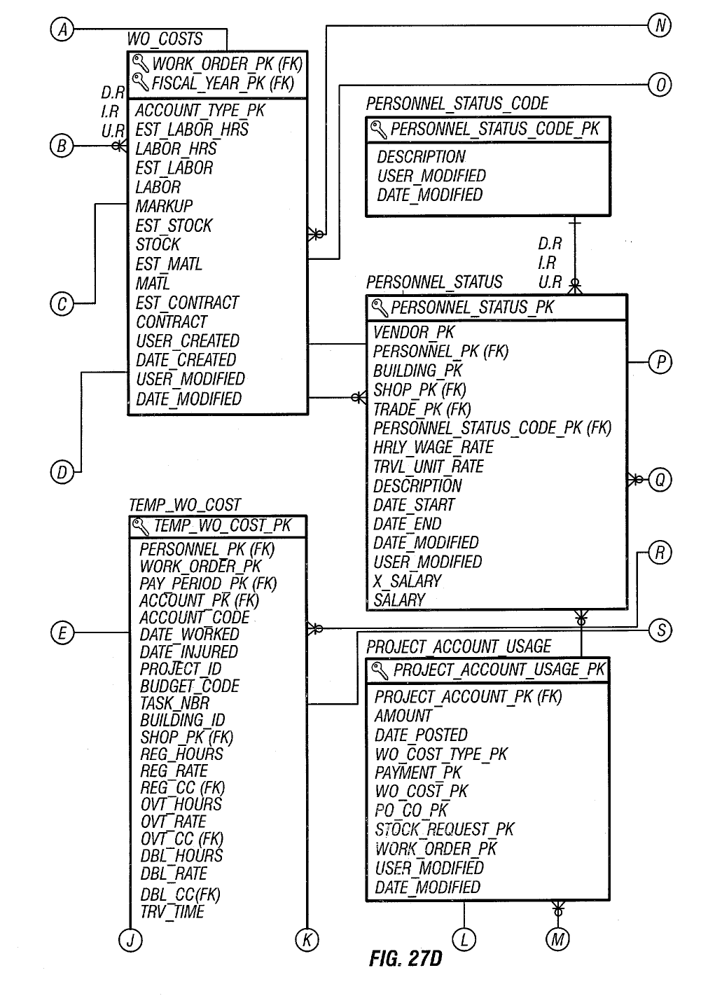

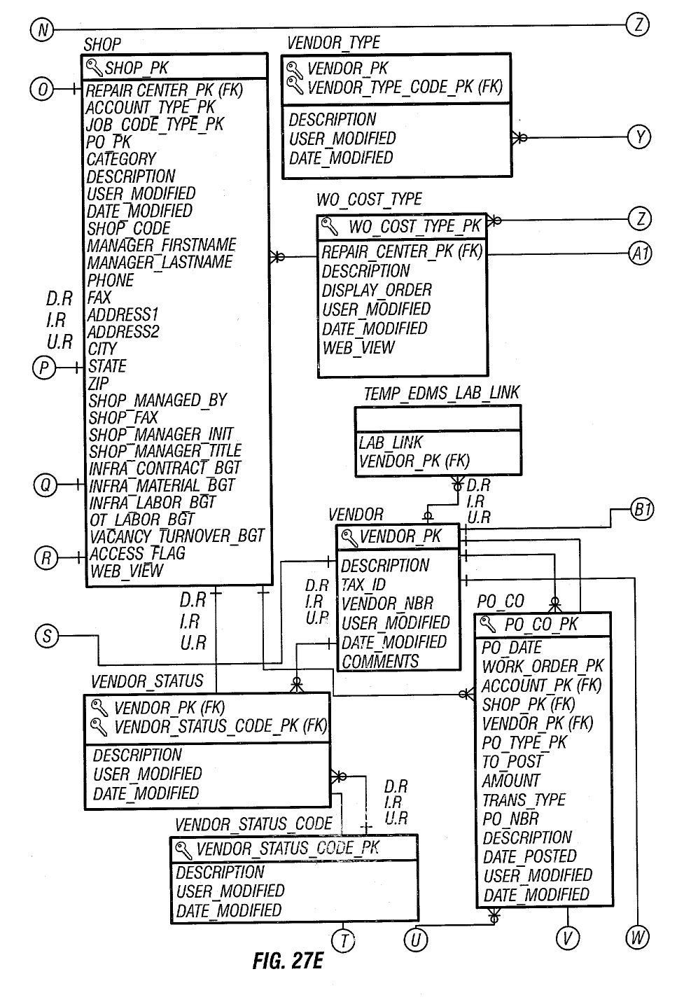

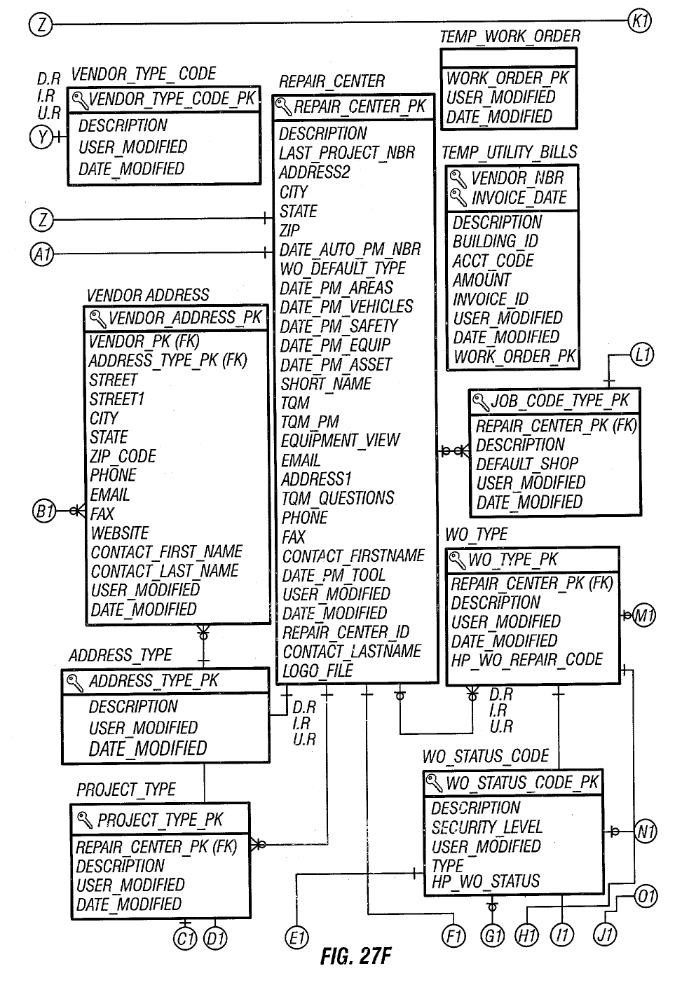

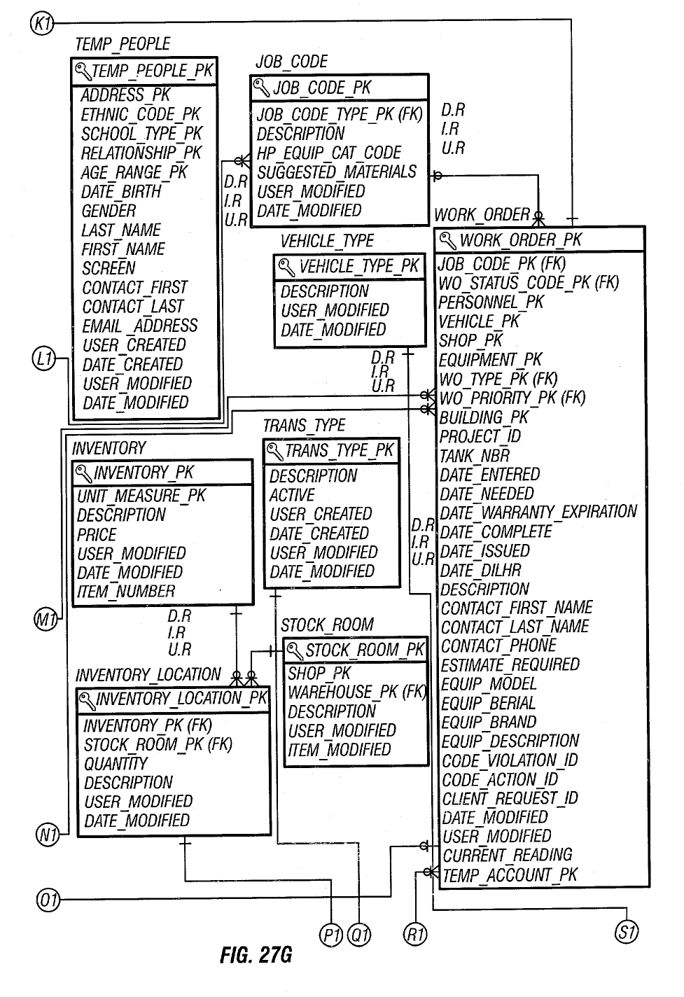

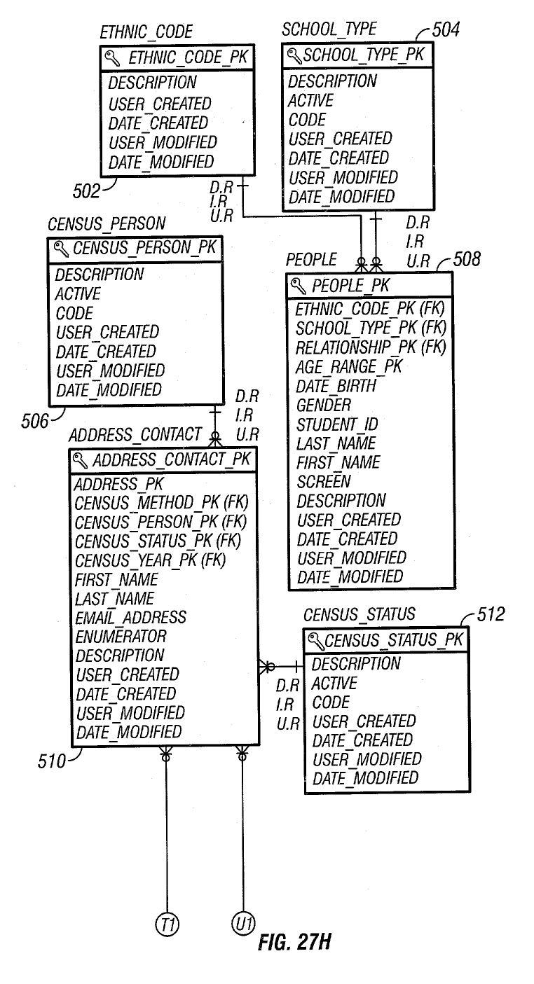

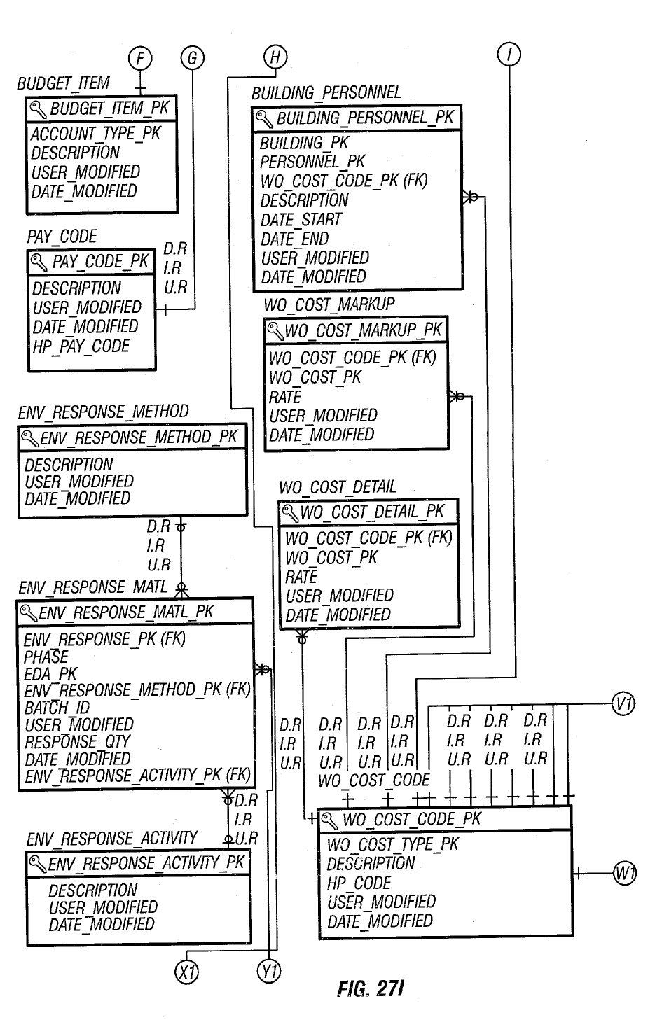

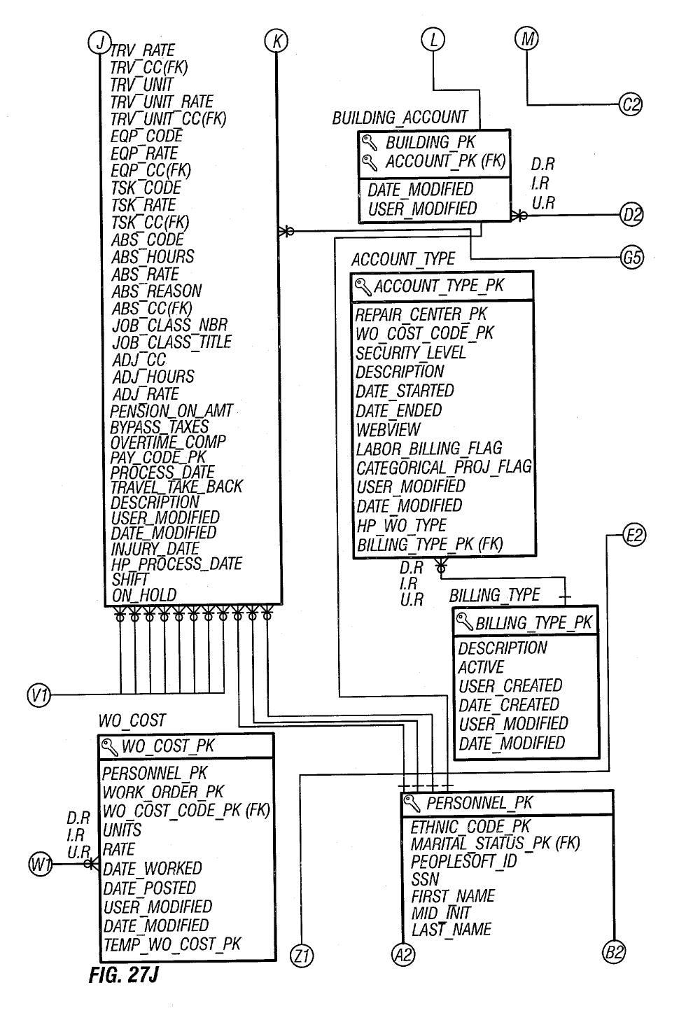

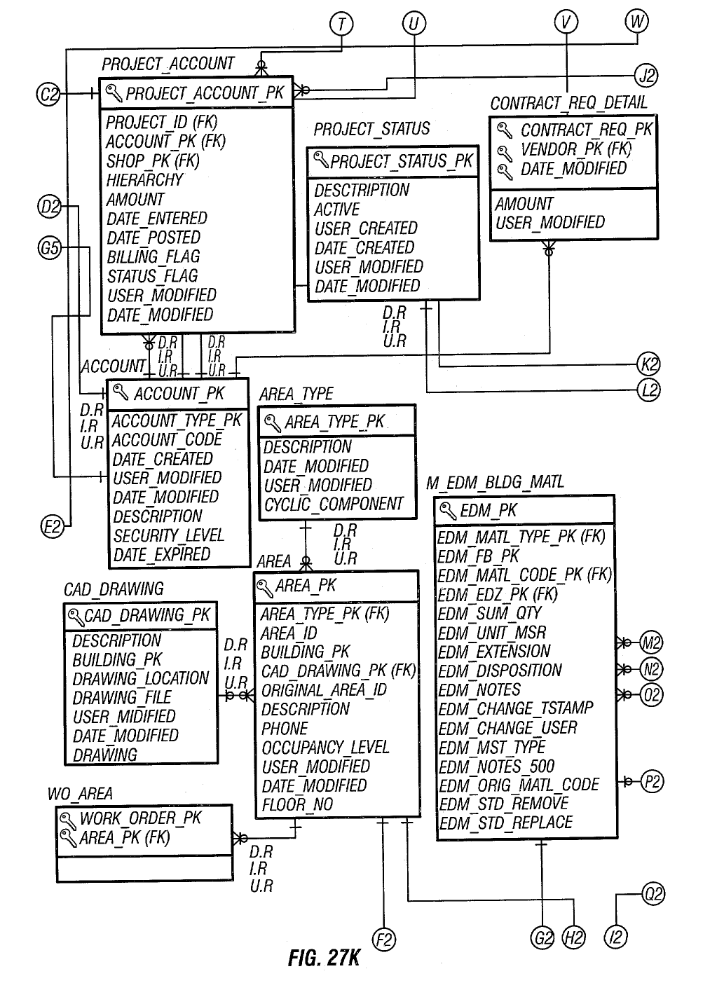

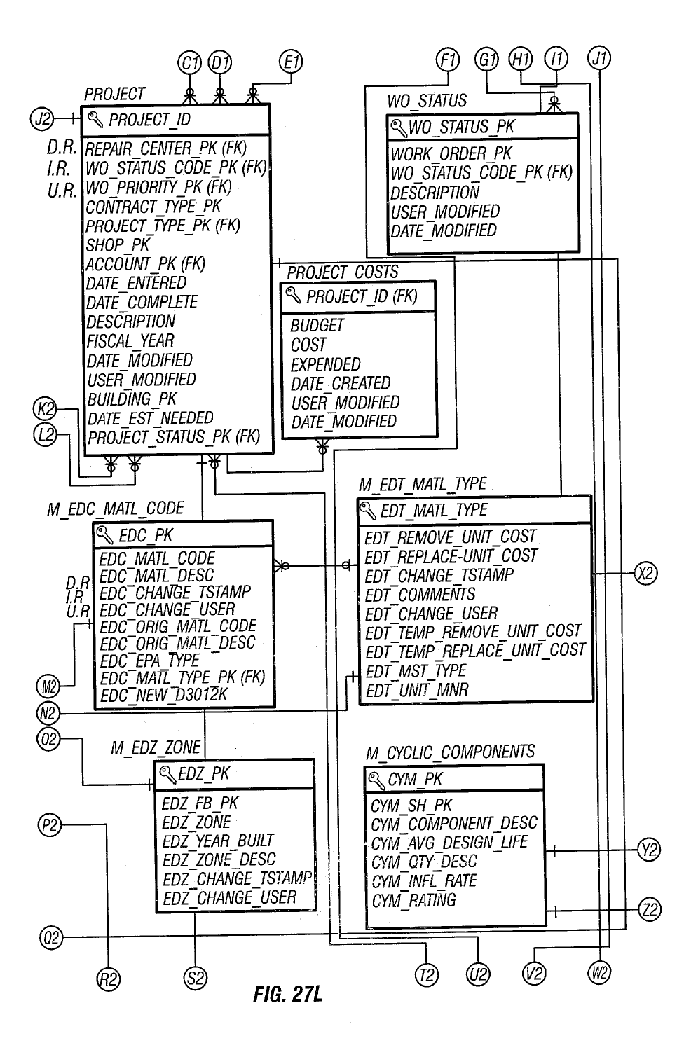

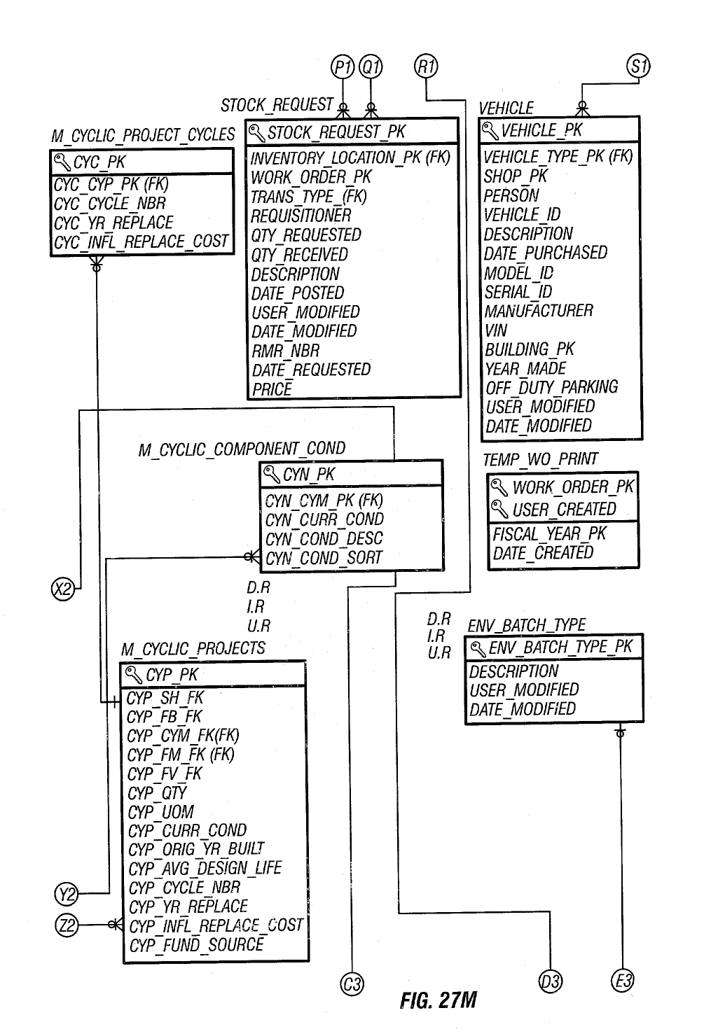

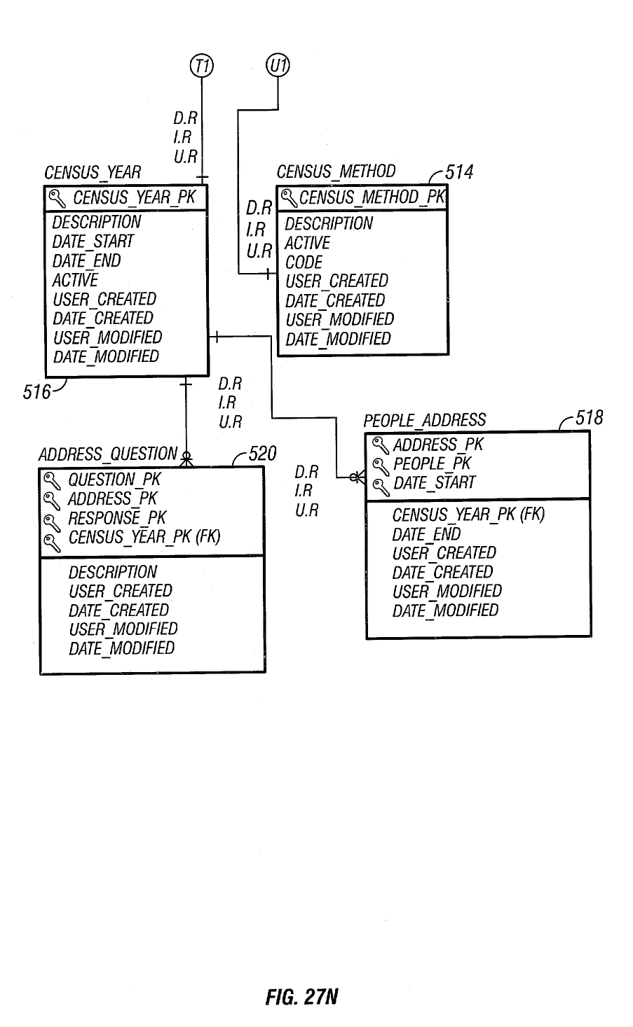

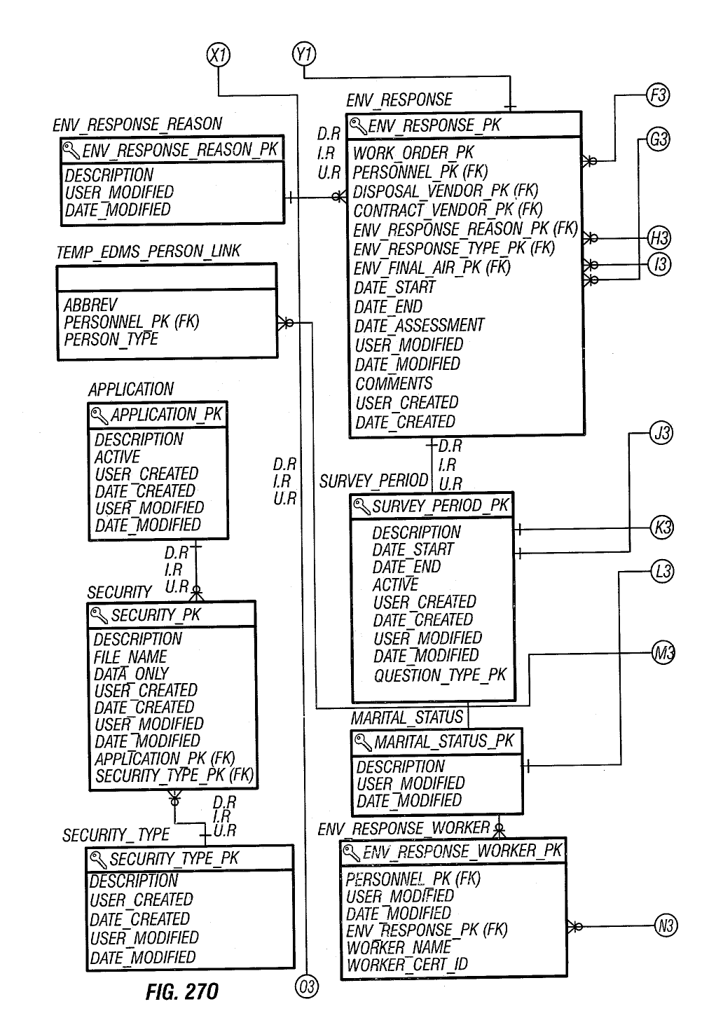

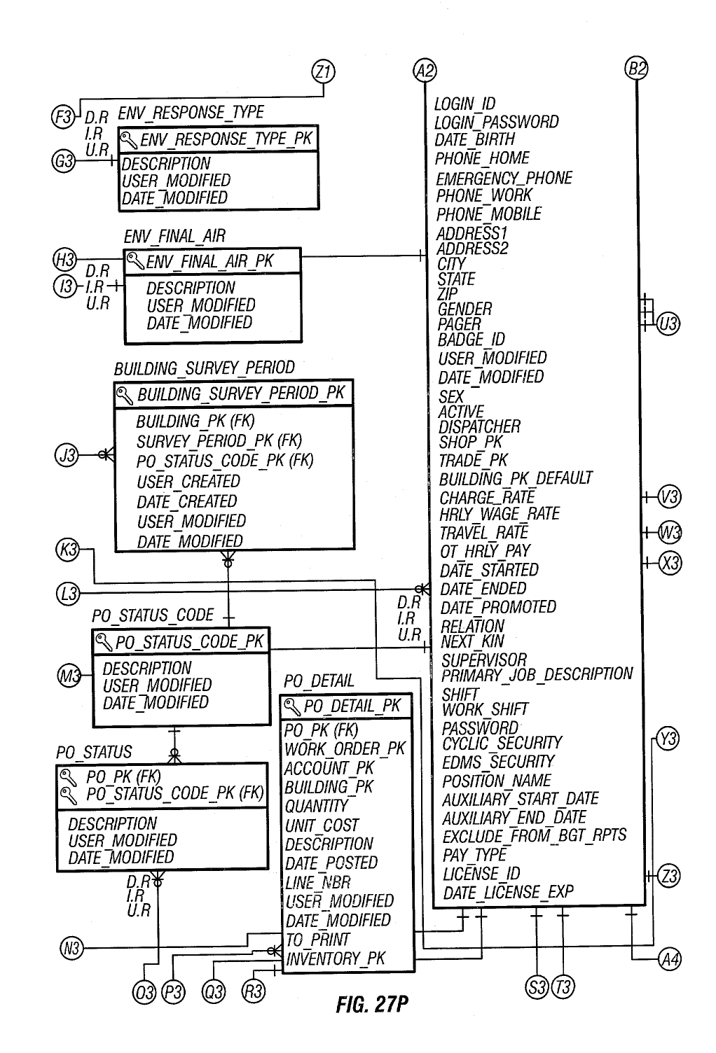

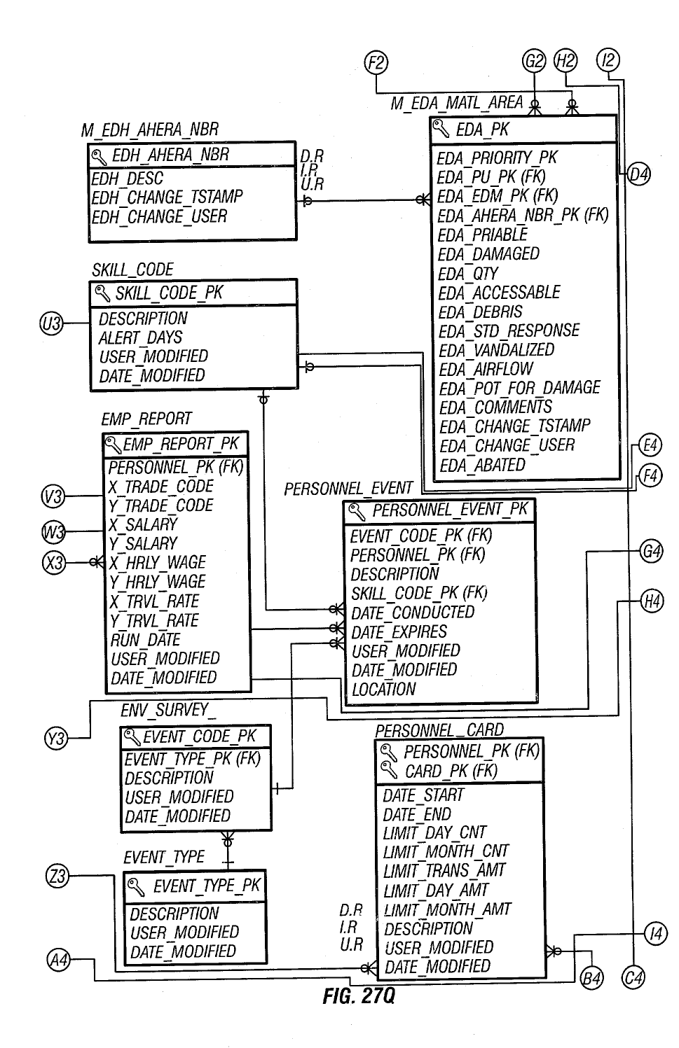

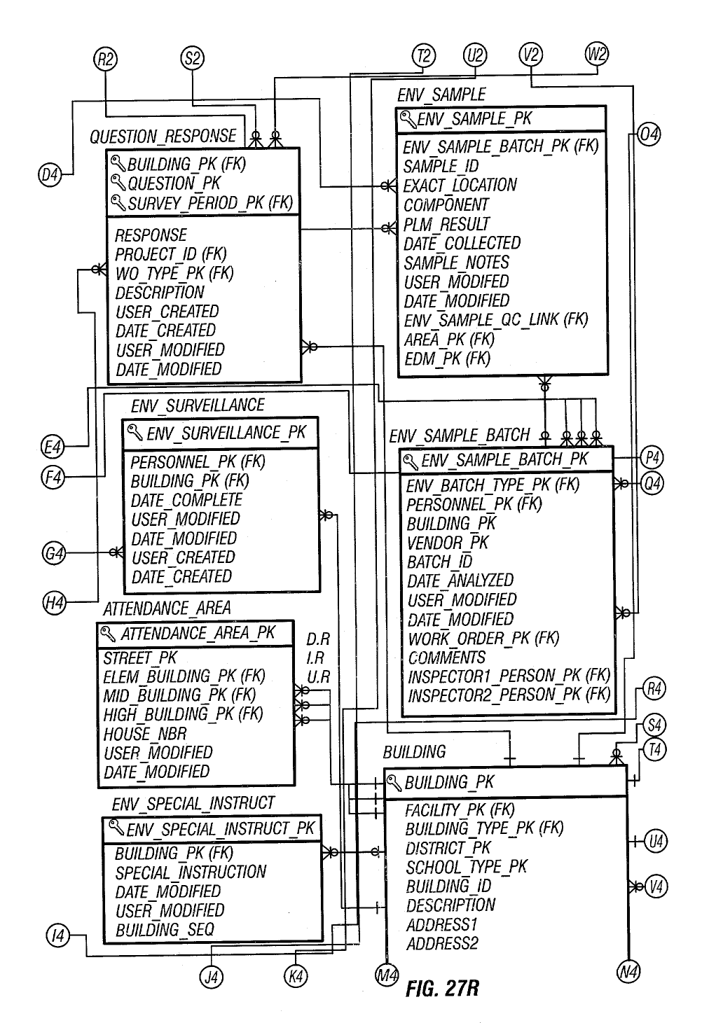

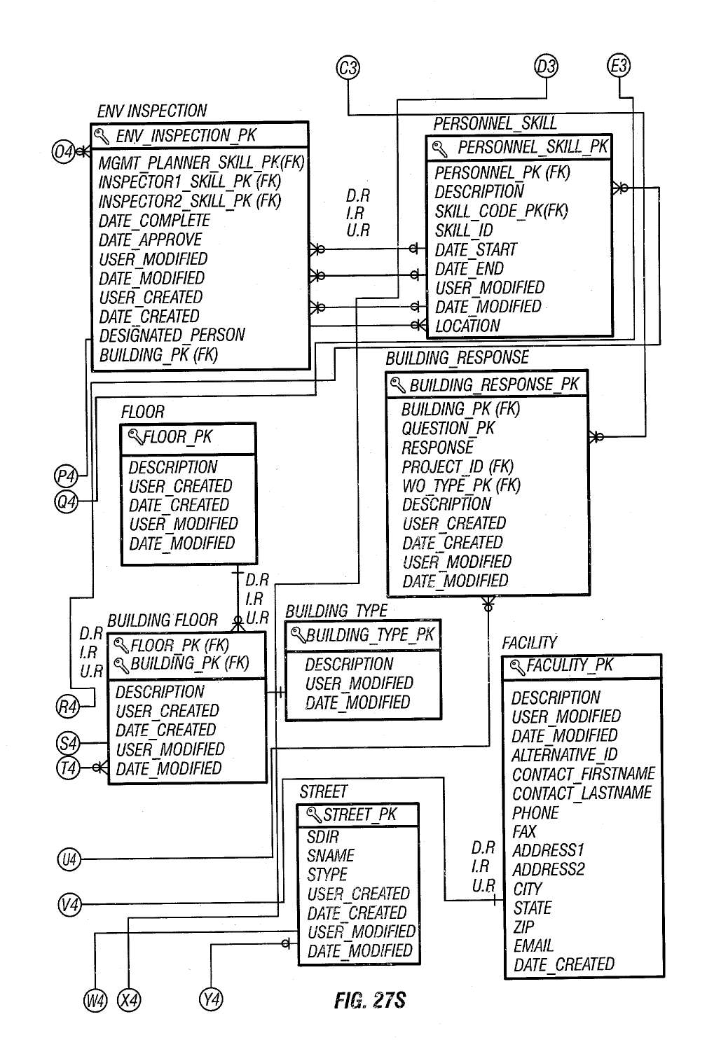

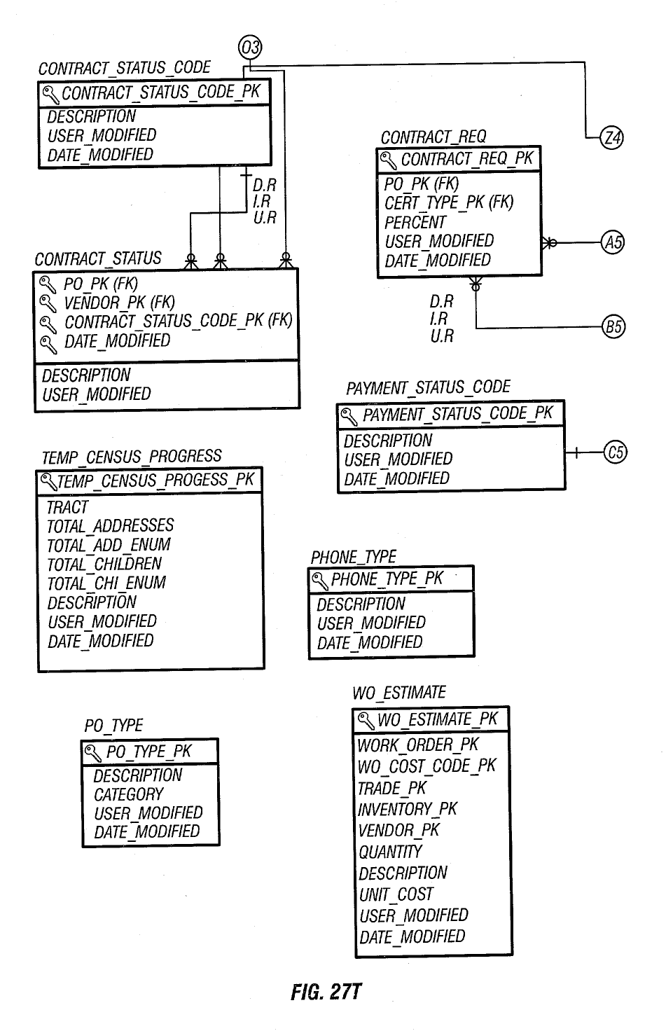

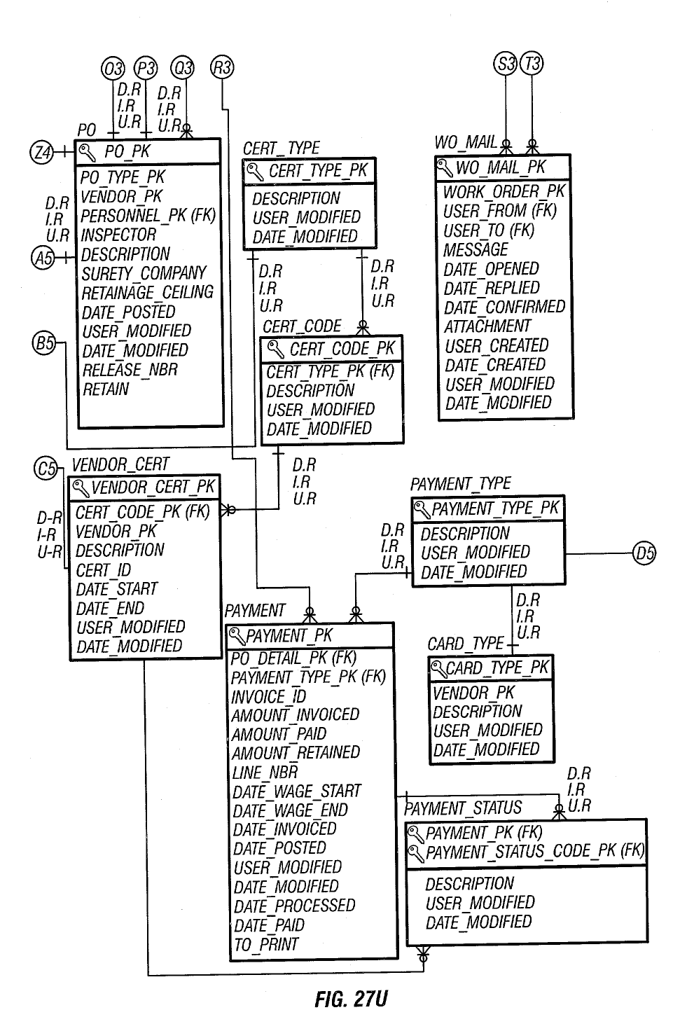

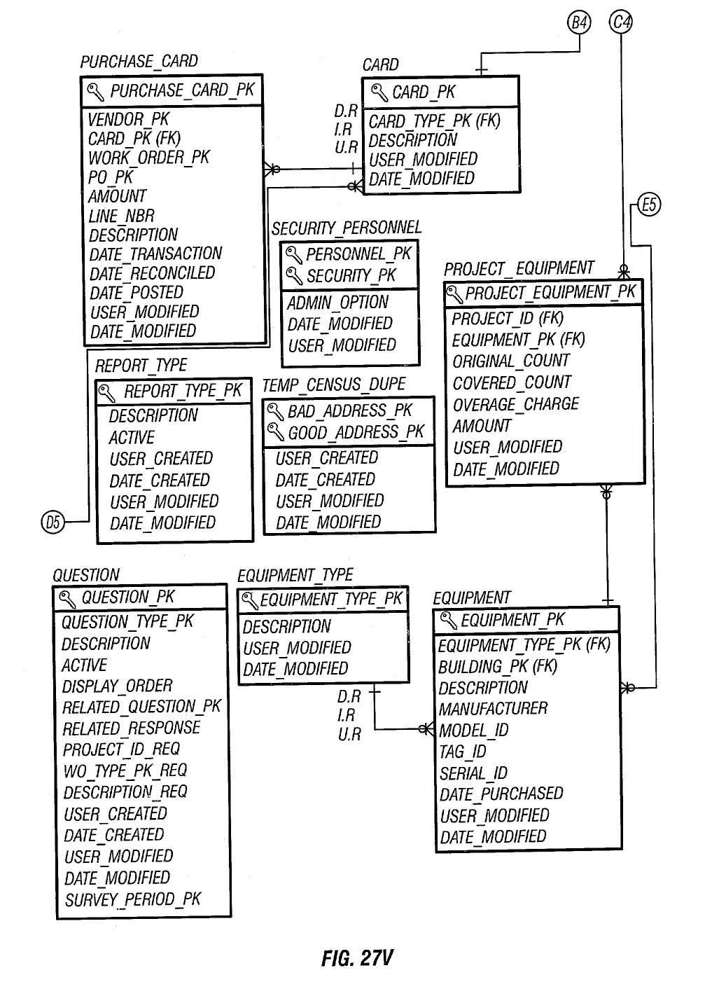

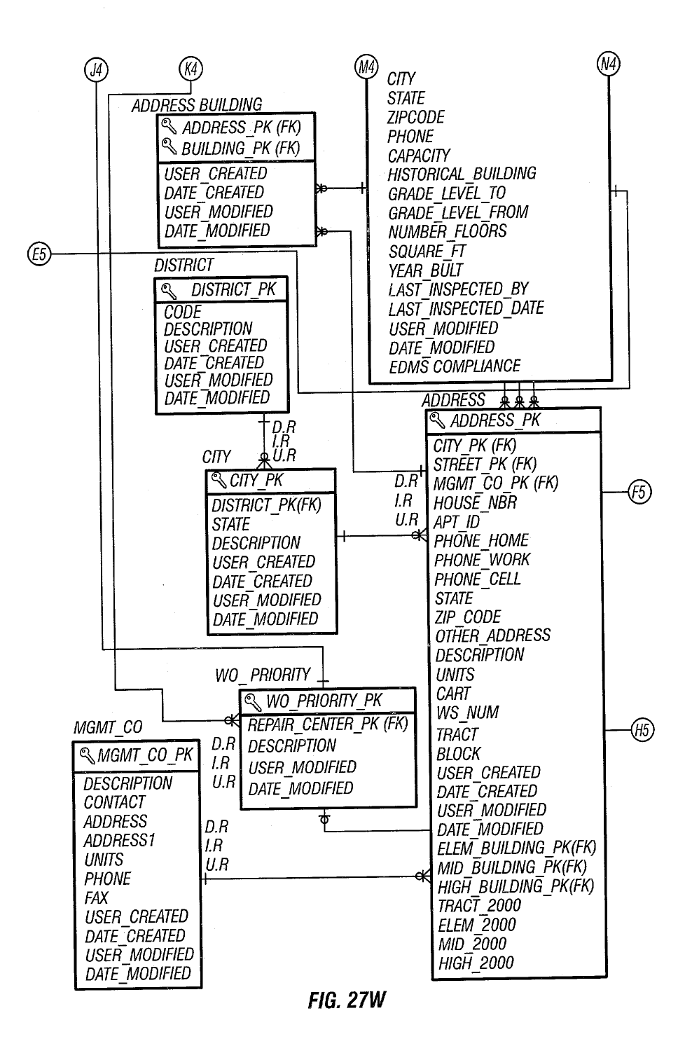

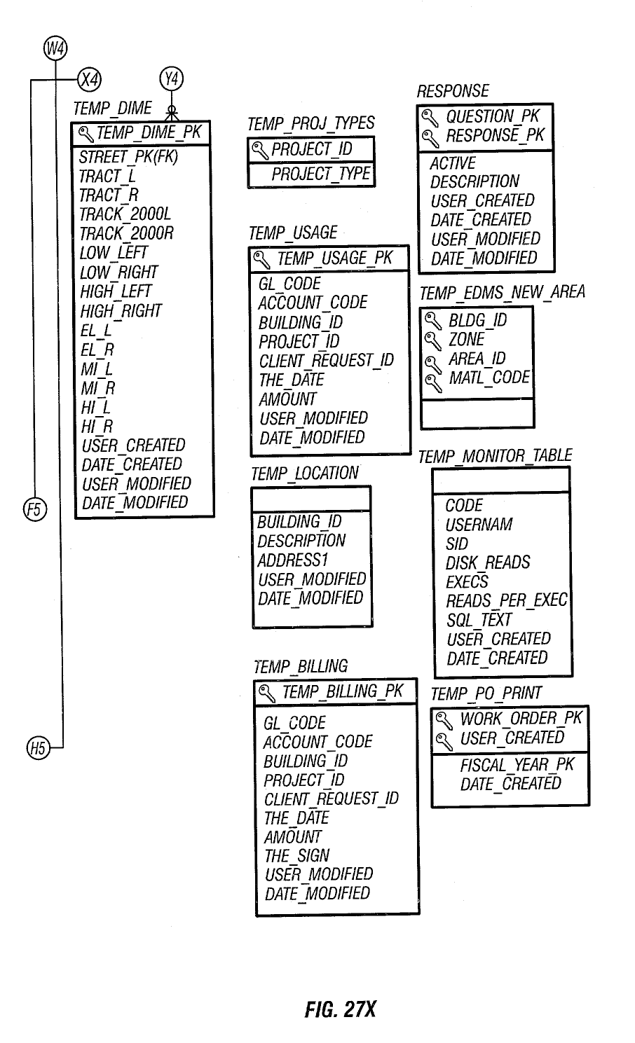

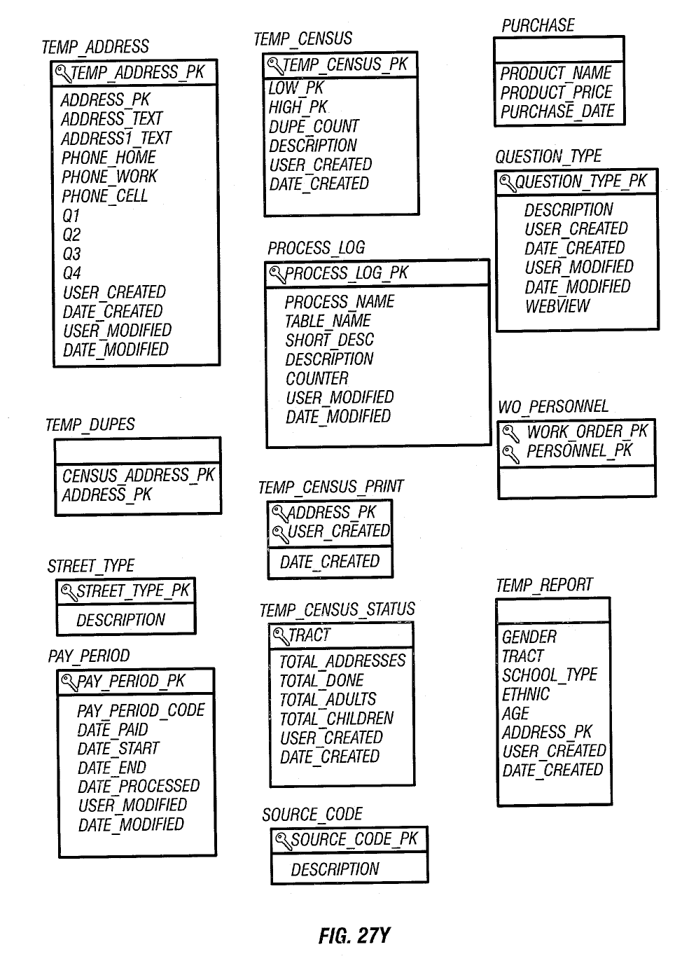

FIGS. 27A-O illustrate a data model 500 that defines the architecture of one embodiment of the system 10. The data model 500 provides a mechanism for linking or relating all of the various components of the system 10. The data model 500 is a graphical representation of a plurality of tables or entities relationally linked to, or associated with, one another by a number of links or branches. A solid line (i.e., link) represents a required relationship where the primary key is migrated from a parent table to a child table. A dotted line (i.e., link) represents a non-required relationship where at least some parts of the primary key may or may not migrate from the parent table to the child table. Cardinality is indicated by the presence of a symbol at the end of a relationship branch. An entity with a child symbol (i.e., crowsfeet) next to it is the “child” of at least one “parent” entity. In general, a “parent” entity can have numerous “children.” In other words if the terminating end of a relationship branch has the child symbol (i.e., crowsfeet), an instance of the originating entity can be related to one or more instances of the terminating entity. If the terminating end is a straight line, an instance of the originating entity can be related to only one instance of the terminating entity.

The data model 500 illustrated in FIGS. 27A-O includes a plurality of tables. Each table includes a header and a fields section or detail table. The header generally includes an identification (“ID”) (or primary key) of the table. If a particular table is a child to a parent entity and linked to that parent entity by a solid line, the header may also include an ID (or foreign key) for that parent entity. The fields section typically includes all attributes of the table, and if the table is a child to a parent entity and linked to that parent entity by a dashed line, the fields section may also include a foreign key for that parent entity.

FIG. 27N illustrates the linking between the parent and child tables. FIG. 27N illustrates a portion of the data model 500. FIG. 27N includes tables 502-520. The ADDRESS_CONTACT table 510 includes a header containing an ADDRESS_CONTACT_PK (primary key). The ADDRESS_CONTACT table 510 also includes a fields section containing an ADDRESS_PK, a CENSUS_METHOD_PK (foreign key), a CENSUS_PERSON_PK (a foreign key), a CENSUS_STATUS_PK (a foreign key), a CENSUS_YEAR_PK (a foreign key), and a number of attributes; including a FIRST_NAME, a LAST_NAME, an EMAIL_ADDRESS, an ENUMERATOR, a DESCRIPTION, a USER_CREATED, a DATE_CREATED, a USER_MODIFIED, and a DATE_MODIFIED. The ADDRESS_CONTACT table 510 is a child entity of the CENSUS_PERSON table 506, the CENSUS_STATUS table 512, the CENSUS_METHOD table 514, and the CENSUS_YEAR table 516, which are linked to the ADDRESS_CONTACT table 510 by a dashed line.

The remaining tables illustrated in FIGS. 27A-O are similar to those discussed with respect to tables 502-520 and, for purposes of brevity, are not discussed herein. A person of ordinary skill in the art would understand the remaining figures illustrating other portions of the data model 500.

As can can be seen from the above, the invention provides systems and methods of managing maintenance and operations in relatively large organizations. Various features and advantages are set forth in the following claims.

What is claimed is:

1. A computerized maintenance management and information distribution system comprising:
a shop terminal coupled to a network;
a school terminal coupled to the network;
a public terminal coupled to the network;
an administration terminal coupled to the network;
a central office terminal coupled to the network; and
a server coupled to the network, the server having a site accessible by the shop terminal, the school terminal, the public terminal, the administration terminal, and the central office terminal, the site including tools to manage maintenance and operations of a facility, the tools built upon a database model that defines relationships among the modules.

2. The system as claimed in claim 1, further comprising a database coupled to the server.

3. The system as claimed in claim 1, further comprising a wireless terminal having access to the network.

4. The system as claimed in claim 3, wherein the wireless terminal communicates with one of a computerized hand-held device and a cell phone.

5. The system as claimed in claim 1, wherein the tools include:
a work order module;
an employee resource module;
a materials and inventory module;
a purchase order module;
a reporting module;
a time sheet entry module;
an environmental data management module;
a census application module;
a cyclic maintenance module;
an image viewer module; and
a setup and security module.

6. The system as claimed in claim 5, further comprising:
a school safety module coupled to the work order module and the cyclic maintenance module;
a work order request module coupled to the work order module;
a commitment of money module coupled to the work order module, the materials and inventory module, and the purchase order module;
an automatic identification module coupled to the work order module, the employee resource module, the materials and inventory module, the purchase order module, and the commitment of money module; and
a purchasing card module coupled to the purchase order module.

7. The system as claimed in claim 5, further comprising a city mapping database wherein the census application module is configured to utilize a secure data sharing application operable to access the city mapping database.

8. The system as claimed in claim 5, further comprising a server wherein the work order module, the employee resource module, the materials and inventory module, the purchase order module, the reporting module, the time sheet entry module, the environmental data management module, the census application module, the cyclic maintenance module, the image viewer module, and the setup and security module are coupled to the server.

9. A work order module for use in a computerized maintenance management and information distribution system, the work order module operable to generate:
a summary screen to view an existing work order based on a shop code;
a search screen to search for a work order; and
a detail screen to enter data describing the nature of the work performed on a work order.

10. The module as claimed in claim 9 further comprising an estimate screen to prepare an estimate to complete the work order.

11. The module as claimed in claim 9, wherein the summary screen displays the existing work orders based on a status code.

12. The module as claimed in claim 11, wherein the status code is one of a new code, a planning code, a pending code, an active code, and a closed code.

13. The module as claimed in claim 9, wherein the shop code is based on the shop code in a shop terminal.

14. A computerized work order request module for use in a computerized maintenance management and information distribution system, the work order request module operable to generate:
a preview screen to view an existing work order and select an existing work order for review;
a detail screen to enter data describing the nature of a work order request; and
an image screen to view floor plans and select the area for the work order request.

15. The module as claimed in claim 14, wherein the preview screen displays the existing work orders for a particular building.

16. The module as claimed in claim 14, wherein the preview screen displays the existing work orders based on a status code.

17. The module as claimed in claim 16, wherein the status code is one of a new value, a planning value, a pending code, an active code, and a closed code.

18. The module as claimed in claim 14, further comprising a search screen to search for existing work orders based on a date.

19. The module as claimed in claim 14, wherein the detail screen includes a data field for an account value.

20. The module as claimed in claim 19, wherein the account value is used to track the costs associated with the work order.

21. The module as claimed in claim 14, wherein the detail screen includes a data field for an estimate value to indicate a request for an estimate prior to beginning work on the work order.

22. A method of communicating a computerized work order request to multiple parties having access to a computerized maintenance management and information distribution system, the method comprising the acts of:
accessing a site on a server using a computer terminal;
entering data on at least one work order request screen to describe the nature of the work order request; and
transmitting the work order request information to the server and to other computer terminals.

23. The method of claim 22, wherein the act of entering data on at least one work order request screen includes at least one of a payment method, a location for the repair, a repair description, and a requester information.

24. A method of retrieving an existing work order stored on a computerized maintenance management and information distribution system, the method comprising the acts of:
accessing a site using a computer terminal having access to the network;
entering data on at least one work order search screen to describe the work order to be retrieved; and
displaying work order request information on the computer terminal.

25. The method of claim 24, wherein the act of entering data on at least one work order search screen is one of a status of the work order request, a date range, and a building.

26. A purchase order and credit card module for use in a computerized maintenance management and information distribution system, the purchase order and credit card module operable to generate:
a vendor screen to identify the vendor of a purchase order;
a billing screen to display the costs of the vendor to complete the purchase order;
a payment screen to display the amount to be paid to the vendor of the purchase order; and
an authorization screen to authorize the purchase order for payment.

27. The module as claimed in claim 26, wherein the purchase order is linked to a work order.

28. The module as claimed in claim 26, wherein the vendor screen identifies preferred vendors.

29. A materials and inventory module for use in a computerized maintenance management and information distribution system, the materials and inventory module operable to generate:
a search screen to search for an inventory item;
an inventory screen to identify the availability of the inventory item;
an inventory requisition screen to remove the inventory item from stock; and
a report screen to generate inventory reports.

30. The module as claimed in claim 29, wherein the search screen includes a data field for a search category value.

31. The module as claimed in claim 30, wherein the search category value is one of an item number and a description.

32. The module as claimed in claim 29, wherein the inventory screen identifies the location of the inventory item.

33. A method of requisitioning an inventory item using a materials and inventory module for a computerized maintenance management and information distribution system, the method comprising the acts of:
accessing a site on a server using a computer terminal;
entering data on at least one inventory screen to describe the inventory item;
displaying inventory information of the inventory item on the computer terminal;
entering a quantity requested value on the at least one inventory screen; and
transmitting the data entered on the at least one inventory screen to the server.

34. The method as claimed in claim 33, wherein the act of entering data on at least one inventory screen is performed using one of a computerized hand-held device and a cell phone.

35. The method as claimed in claim 33, wherein the act of entering data on at least one inventory screen includes entering one of an item number and a description.

36. The method as claimed in claim 35, wherein the act of entering data on at least one inventory screen includes entering a portion of the item number.

37. The method as claimed in claim 35, wherein the act of entering data on at least one inventory screen includes entering a portion of the description.

38. A time sheet entry module for use in a computerized maintenance management and information distribution system, the time sheet entry module operable to generate:
a time entry screen to enter time worked data;
a search screen to search for an employee;
a summary screen to review the data entered on the time entry screen; and
a report screen to generate labor reports.

39. The module as claimed in claim 38, further comprising a payroll screen to transmit the time worked data to the organization's payroll check processor.

40. The module as claimed in claim 38, wherein the report screen is operable to generate labor reports including time, attendance, and work performed information for one or more employees.

41. The module as claimed in claim 38, wherein the time worked data entered on the time entry screen is linked to a work order.

42. The module as claimed in claim 41, wherein the time worked data entered on the time entry screen cannot be more than the time worked on the work order.

43. An environmental data management module for use in a computerized maintenance management and information distribution system, the environmental data management module operable to generate:
a menu screen to access environmental information;
a search screen to select a location for reviewing environmental information;
an environmental data screen to view environmental information for the location; and
a report screen to generate an environmental report.

44. The module as claimed in claim 43, wherein the environmental information includes one of asbestos, blood-borne pathogens, indoor air quality, lead-based paint, PCB, potable water, and confined space.

45. The module as claimed in claim 43, wherein the menu screen includes access to material safety data sheets.

46. The module as claimed in claim 43, wherein the search screen to select a location includes one of a site selection value and a material type selection value.

47. A census application module for use in a computerized maintenance management and information distribution system, the census application module operable to generate:
an address screen to identify a location for obtaining census information;
an occupants screen to identify the persons residing at the location on the address screen;
a questions screen to identify questions to ask the persons in the occupants screen; and
a contacts screen to identify other persons used to obtain the census information for the location.

48. The module as claimed in claim 47, wherein the address screen includes an address for each location in a city.

49. The module as claimed in claim 48, wherein the address for each location is compared to a city mapping database to avoid duplicate addresses.

50. A cyclic maintenance module for use in a computerized maintenance management and information distribution system, the cyclic maintenance module operable to generate:
a cyclic maintenance screen to identify a primary component;
a search screen to select the primary component of interest;
an inflation rate screen to identify the annual inflation rate; and
a cost screen to identify the cost to replace the primary component based on the inflation rate.

51. The module as claimed in claim 50, wherein the primary component is a major maintenance project.

52. The module as claimed in claim 50, wherein the search screen includes the age of the primary component.

53. The module as claimed in claim 50 further comprising a condition screen to indicate the condition of the primary component.

54. The module as claimed in claim 50 further comprising a recalculate screen to calculate replacement costs based on a new inflation rate.

55. The module as claimed in claim 50 further comprising a report screen to provide comparison information of the primary components in a structure.

56. The module as claimed in claim 50 further comprising a score calculated for the structure to indicate the overall condition of the structure.

57. The module as claimed in claim 56, wherein the score includes a weight factor and a rating of the condition of the primary components of the structure.

58. A school safety module for use in a computerized maintenance management and information distribution system, the school safety module operable to generate:
an automatic checklist to review items for periodic maintenance;
a survey screen to indicate the condition of the item; and
a questionnaire screen to answer questions related to the item.

59. The module as claimed in claim 58, wherein the automatic checklist is available on a computerized hand-held device.

60. The module as claimed in claim 58, wherein the survey screen is linked to a work order.

61. The module as claimed in claim 58, wherein the questionnaire screen includes a data field to indicate whether vandalism affected the item.
